(19) United States
(12) Patent Application Publication
(10) Pub. No.: US 2025/0110418 A1
(43) Pub. Date: Apr. 3, 2025

(54) LIGHT SCANNING APPARATUS AND IMAGE FORMING APPARATUS

(71) Applicant: CANON KABUSHIKI KAISHA, Tokyo (JP)

(72) Inventor: RYOTA SATO, Tochigi (JP)

(21) Appl. No.: 18/884,361

(22) Filed: Sep. 13, 2024

(30) Foreign Application Priority Data
Sep. 28, 2023 (JP) 2023-166647

(51) Int. Cl. G03G 15/04

(52) U.S. Cl. CPC G03G 15/0409; G03G 15/04036; G03G 2215/0404

(57) ABSTRACT

A light scanning apparatus according to the present embodiments includes a deflecting unit configured to deflect a first light flux to scan a first scanned surface in a main scanning direction, a first imaging optical system configured to guide the first light flux deflected by the deflecting unit to the first scanned surface, a light receiving element configured to receive the first light flux deflected by the deflecting unit without the first imaging optical system, a first optical element configured to guide the first light flux deflected by the deflecting unit to the light receiving element, and a holding member configured to hold the deflecting unit, the first imaging optical system, the light receiving element and the first optical element, in which the first optical element and the deflecting unit are arranged on sides opposite to each other with respect to a first surface of the holding member.

### BACKGROUND

### Technical Field

The present disclosure is related to a light scanning apparatus, and more particularly, to a light scanning apparatus suitably used in an image forming apparatus such as a laser beam printer, a digital copying machine, or a multifunction printer.

### Description of the Related Art

Conventionally, there is known a light scanning apparatus including an optical element for so-called synchronization detection for controlling writing timing on a scanned surface.

Japanese Patent Application Laid-open No. 2005-62516 discloses a light scanning apparatus in which a light receiving element for receiving a light flux for synchronization detection, and a synchronization detection optical element for guiding the light flux to the light receiving element are arranged on opposite side of a deflecting unit relative to a substrate provided on a predetermined main scanning cross section.

### SUMMARY

A light scanning apparatus according to the embodiments includes a deflecting unit configured to deflect a first light flux to scan a first scanned surface in a main scanning direction, a first imaging optical system configured to guide the first light flux deflected by the deflecting unit to the first scanned surface, a light receiving element configured to receive the first light flux deflected by the deflecting unit without the first imaging optical system, a first optical element configured to guide the first light flux deflected by the deflecting unit to the light receiving element, and a holding member configured to hold the deflecting unit, the first imaging optical system, the light receiving element and the first optical element, in which the first optical element and the deflecting unit are arranged on sides opposite to each other with respect to a first surface of the holding member.

Further features of the present disclosure will become apparent from the following description of exemplary embodiments with reference to the attached drawings.

### BRIEF DESCRIPTION OF THE DRAWINGS

FIG. 1A is a partial developed view in a main scanning cross section of a light scanning apparatus according to a first embodiment of the present invention.

FIG. 1B is a partial developed view in the main scanning cross section of the light scanning apparatus according to the first embodiment.

FIG. 2A is a partial developed view in a sub-scanning cross section of the light scanning apparatus according to the first embodiment.

FIG. 2B is a partial developed view in the sub-scanning cross section of the light scanning apparatus according to the first embodiment.

FIG. 2C is a partial sub-scanning cross sectional view of the light scanning apparatus according to the first embodiment.

FIG. 3A is a partial developed view in the main scanning cross section of the light scanning apparatus according to the first embodiment.

FIG. 3B is a partial sub-scanning cross sectional view of the light scanning apparatus according to the first embodiment.

FIG. 4 is a sub-scanning cross sectional view of a first imaging optical element provided in the light scanning apparatus according to the first embodiment.

FIG. 5 is a partial projected view in the main scanning cross section of the light scanning apparatus according to the first embodiment.

FIG. 6 is a partial enlarged sectional view of the light scanning apparatus according to the first embodiment.

FIG. 7A is a graph showing an image height dependence of a LSF depth center position in a main scanning direction on each scanned surface in the light scanning apparatus according to the first embodiment.

FIG. 7B is a graph showing an image height dependence of a LSF depth center position in a sub-scanning direction on each scanned surface in the light scanning apparatus according to the first embodiment.

FIG. 8A is a partial developed view in the main scanning cross section of the light scanning apparatus according to the first embodiment.

FIG. 8B is a partial sub-scanning cross sectional view of the light scanning apparatus according to the first embodiment.

FIG. 9A is a partial developed view in the main scanning cross section of the light scanning apparatus according to a second embodiment of the present invention.

FIG. 9B is a partial sub-scanning cross sectional view of the light scanning apparatus according to the second embodiment.

FIG. 10A is a partial developed view in the main scanning cross section of the light scanning apparatus according to the second embodiment.

FIG. 10B is a partial sub-scanning cross sectional view of the light scanning apparatus according to the second embodiment.

FIG. 11A is a view showing an image height dependence of the LSF depth center position in the main scanning direction on each scanned surface in the light scanning apparatus according to the second embodiment.

FIG. 11B is a view showing an image height dependence of the LSF depth center position in the sub-scanning direction on each scanned surface in the light scanning apparatus according to the second embodiment.

FIG. 12A is a partial developed view in the main scanning cross section of the light scanning apparatus according to a third embodiment of the present invention.

FIG. 12B is a partial sub-scanning cross sectional view of the light scanning apparatus according to the third embodiment.

FIG. 13A is a partial developed view in the main scanning cross section of the light scanning apparatus according to the third embodiment.

FIG. 13B is a partial sub-scanning cross sectional view of the light scanning apparatus according to the third embodiment.

FIG. 14A is a view showing an image height dependence of the LSF depth center position in the main scanning direction on each scanned surface in the light scanning apparatus according to the third embodiment.

FIG. 14B is a view showing an image height dependence of the LSF depth center position in the sub-scanning direction on each scanned surface in the light scanning apparatus according to the third embodiment.

FIG. 15 is a sub-scanning cross sectional view of a main part of an image forming apparatus according to the present embodiments.

### DESCRIPTION OF THE EMBODIMENTS

Hereinafter, a light scanning apparatus according to the present embodiments is described in detail with reference to the accompanying drawings. The drawings described below may be drawn on a scale different from the actual scale in order to facilitate understanding of the present disclosure.

In the following description, a main scanning direction is a direction perpendicular to a rotation axis of a deflecting unit and an optical axis of an imaging optical system (a direction in which a light flux is deflected by the deflecting unit), and a sub-scanning direction is a direction parallel to the rotation axis of the deflecting unit. Further, a main scanning cross section is a cross section perpendicular to the sub-scanning direction, and a sub-scanning cross section is a cross section perpendicular to the main scanning direction.

Further, hereinafter, a direction parallel to the optical axis of the imaging optical system is defined as an X direction, the main scanning direction is defined as a Y direction, and the sub-scanning direction is defined as a Z direction.

### First Embodiment

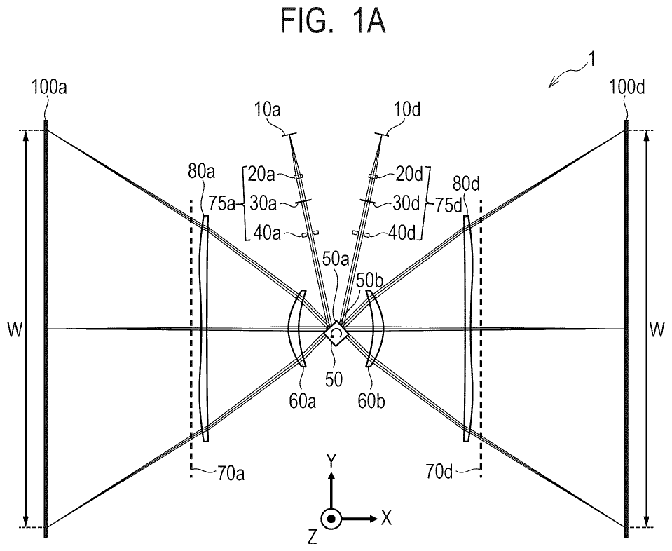

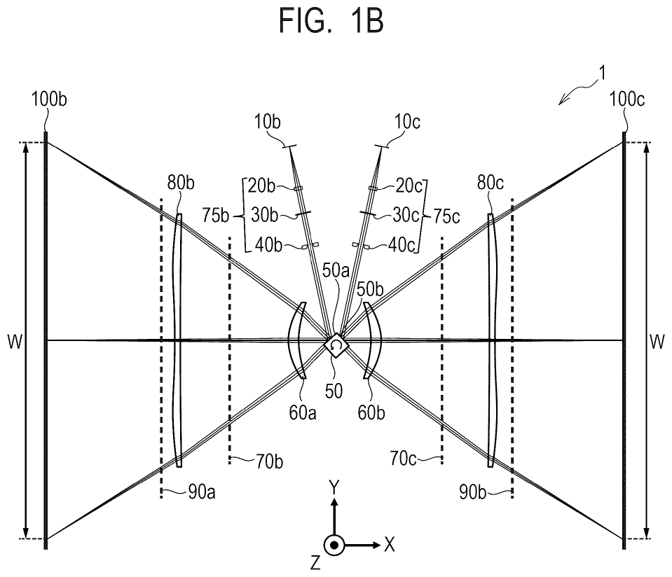

FIGS. 1A and 1B show partial developed views in a main scanning cross section of a light scanning apparatus 1 according to a first embodiment of the present invention.

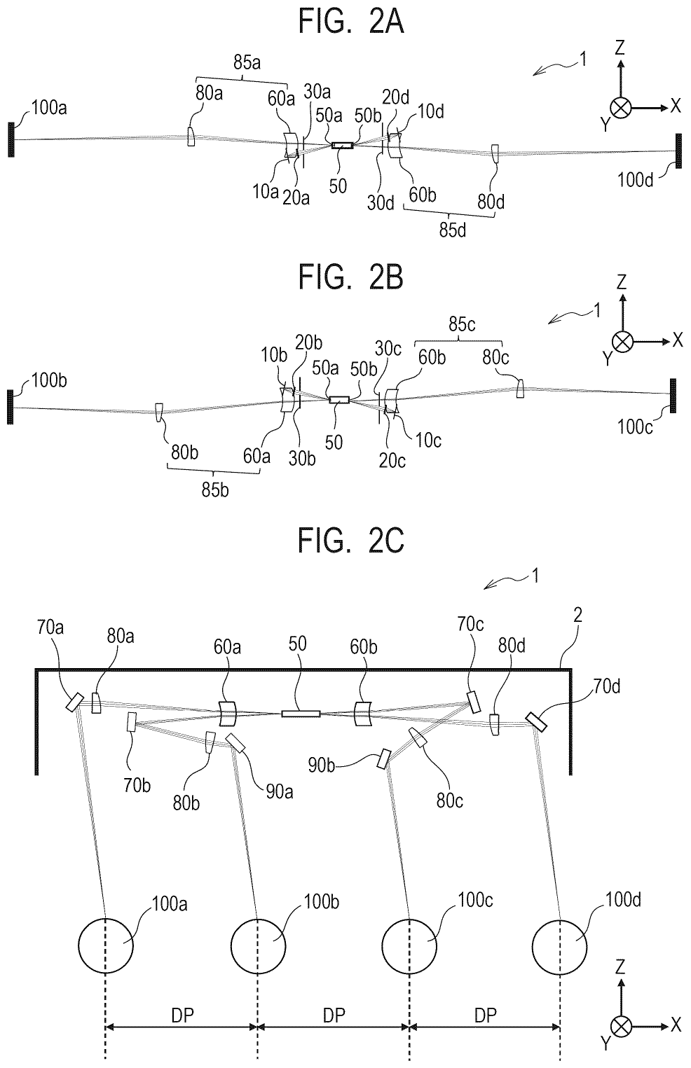

Further, FIGS. 2A and 2B show partial developed views in a sub-scanning cross section of the light scanning apparatus 1 according to the first embodiment.

Furthermore, FIG. 2C shows a partial sub-scanning cross sectional view of the light scanning apparatus 1 according to the first embodiment.

Specifically, FIGS. 1A and 2A illustrate a first incident optical system 75a and a first imaging optical system 85a which are configured to guide a first light flux LA to a first scanned surface 100a.

Further, FIGS. 1A and 2A illustrate a fourth incident optical system 75d and a fourth imaging optical system 85d which are configured to guide a fourth light flux LD to a fourth scanned surface 100d.

In addition, specifically, FIGS. 1B and 2B illustrate a second incident optical system 75b and a second imaging optical system 85b which are configured to guide a second light flux LB to a second scanned surface 100b.

Further, FIGS. 1B and 2B illustrate a third incident optical system 75c and a third imaging optical system 85c which are configured to guide a third light flux LC to a third scanned surface 100c.

Note that first reflecting elements (reflecting optical elements) 70a, 70b, 70c and 70d, and second reflecting elements (reflecting optical elements) 90a and 90b are shown by broken lines in FIGS. 1A and 1B, whereas are not shown in FIGS. 2A and 2B.

The light scanning apparatus 1 according to the present embodiment includes a housing 2 (a holding member), first, second, third and fourth light sources 10a, 10b, 10c and 10d, and first, second, third and fourth incident optical elements 20a, 20b, 20c and 20d.

The light scanning apparatus 1 according to the present embodiment includes first, second, third and fourth sub-scanning stops 30a, 30b, 30c and 30d, and first, second, third and fourth main scanning stops 40a, 40b, 40c and 40d, and a deflecting unit 50.

The light scanning apparatus 1 according to the present embodiment includes first imaging optical elements 60a and 60b, and first reflecting elements 70a, 70b, 70c and 70d.

The light scanning apparatus 1 according to the present embodiment includes second imaging optical elements 80a, 80b, 80c and 80d, and second reflecting elements 90a and 90b (second optical elements).

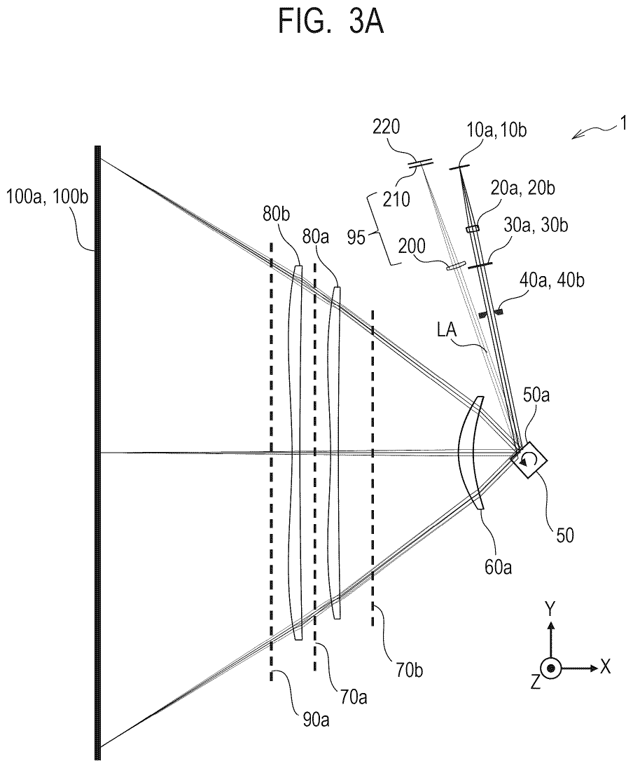

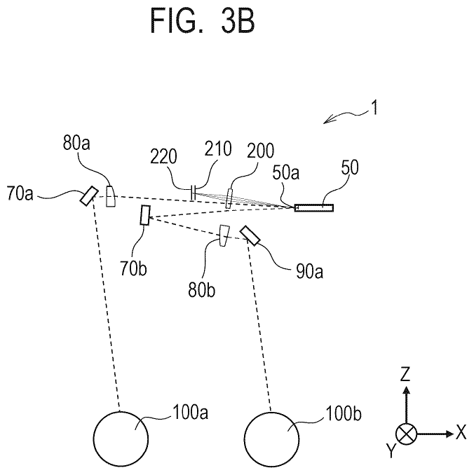

Further, the light scanning apparatus 1 according to the present embodiment includes a synchronization detection lens 200 (a first optical element, a refracting optical element), a synchronization detection slit 210 and a synchronization detection sensor 220 (a light receiving element) (see FIG. 3A).

The light scanning apparatus 1 according to the present embodiment adopts a so-called both-side scanning system configured to scan first and second scanned surfaces 100a and 100b, and third and fourth scanned surfaces 100c and 100d provided on an opposite side of the first and second scanned surfaces 100a and 100b with respect to the deflecting unit 50 in the main scanning cross section.

The housing 2 includes a box portion having an internal space in which each optical element provided in the light scanning apparatus 1 according to the present embodiment is placed, and a lid portion for covering the internal space from a top of the box portion, and is configured to accommodate the respective optical elements while holding them.

The first to fourth light sources 10a to 10d are light sources such as semiconductor lasers each of which has two light emitting points. That is, the light scanning apparatus 1 according to the present embodiment is provided with a total of eight light emitting points.

The first light source 10a and the second light source 10b are arranged at the same positions in the main scanning cross section, whereas are arranged at different positions in the sub-scanning direction.

The third light source 10c and the fourth light source 10d are arranged at the same positions in the main scanning cross section, whereas are arranged at different positions in the sub-scanning direction.

Each of the first to fourth incident optical elements 20a to 20d is an anamorphic lens having different refractive powers between the main scanning cross section and the sub-scanning cross section.

Then, the first to fourth incident optical elements 20a to 20d convert the first to fourth light fluxes LA to LD emitted from the first to fourth light sources 10a to 10d into parallel light fluxes in the main scanning direction, respectively. Note that the parallel light flux includes not only a strictly parallel light flux but also a substantially parallel light flux such as a weakly divergent light flux or a weakly convergent light flux.

Further, the first to fourth incident optical elements 20a to 20d condense the first to fourth light fluxes LA to LD emitted from the first to fourth light sources 10a to 10d toward the deflecting unit 50 in the sub-scanning direction, respectively.

The first to fourth sub-scanning stops 30a to 30d have a rectangular opening portion, and limit light flux diameters in the sub-scanning direction of the first to fourth light fluxes LA to LD that have passed through the first to fourth incident optical elements 20a to 20d, respectively.

The first to fourth main scanning stops 40a to 40d have a rectangular opening portion, and limit light flux diameters in the main scanning direction of the first to fourth light fluxes LA to LD that have passed through the first to fourth sub-scanning stops 30a to 30d, respectively.

The deflecting unit 50 is a polygon mirror (a rotary polygon mirror) having four deflecting surfaces, and rotates at a constant speed in a direction of an arrow illustrated in FIGS. 1A and 1B by a driving unit such as a motor (not shown).

Each of the first imaging optical elements 60a and 60b, and the second imaging optical elements 80a to 80d is an fθ lens (a scanning lens) having an fθ characteristic.

Then, the first imaging optical element 60a and the second imaging optical element 80a condense (guide) the first light flux LA deflected by the deflecting unit 50 onto a scanning region (an image forming region) of the first scanned surface 100a to form a spot image on the scanning region.

Further, the first imaging optical element 60a and the second imaging optical element 80b condense (guide) the second light flux LB deflected by the deflecting unit 50 onto a scanning region of the second scanned surface 100b, to form a spot image on the scanning region.

Furthermore, the first imaging optical element 60b and the second imaging optical element 80c condense (guide) the third light flux LC deflected by the deflecting unit 50 onto a scanning region of the third scanned surface 100c to form a spot image on the scanning region.

In addition, the first imaging optical element 60b and the second imaging optical element 80d condense (guide) the fourth light flux LD deflected by the deflecting unit 50 onto a scanning region of the fourth scanned surface 100d to form a spot image on the scanning region.

The first reflecting elements 70a to 70d and the second reflecting elements 90a and 90b are elongated mirrors that have no refractive power to bend optical paths of the first to fourth light fluxes LA to LD deflected by the deflecting unit 50 in the sub-scanning cross section.

Each of the first to fourth incident optical elements 20a to 20d, the first imaging optical elements 60a and 60b, and the second imaging optical elements 80a to 80d provided in the light scanning apparatus 1 according to the present embodiment is a molded lens formed by injection-molding a plastic material.

However, the present invention is not limited thereto, and they may be molded lenses formed by injection-molding of a glass material.

In the light scanning apparatus 1 according to the present embodiment, it is possible to improve productivity and optical performance by using a molded lens in which an optical surface having an aspherical shape can be easily formed and which is suitable for mass production.

Further, the first reflecting elements 70a to 70d, and the second reflecting elements 90a and 90b provided in the light scanning apparatus 1 according to the present embodiment are elongated mirrors formed by forming a film of a reflecting surface on a general elongated glass, but are not limited thereto.

That is, they may be elongated mirrors formed by forming a film of a reflecting surface on a member formed by injection-molding a plastic material, or by mirror-finishing a metal member such as aluminum.

In addition, in the light scanning apparatus 1 according to the present embodiment, the reflecting surfaces included therein are formed in a planar shape having no refractive power, but are not limited thereto, and may be formed in a curved surface shape such as a spherical surface.

The first and second light fluxes LA and LB emitted from the first and second light sources 10a and 10b are converted into substantially parallel light fluxes in the main scanning cross section, and are condensed in the sub-scanning cross section by the first and second incident optical elements 20a and 20b.

Then, the first and second light fluxes LA and LB having passed through the first and second incident optical elements 20a and 20b pass through the first and second sub-scanning stops 30a and 30b, and the first and second main scanning stops 40a and 40b, and are then guided to a shared deflecting surface (first deflecting surface) 50a of the deflecting unit 50.

Thereby, the light flux diameters in the main scanning direction and the sub-scanning direction of the first and second light fluxes LA and LB are limited, and the first and second light fluxes LA and LB are condensed in the sub-scanning direction so as to form a line image long in the main scanning direction in the vicinity of the deflecting surface 50a of the deflecting unit 50.

Further, the third and fourth light fluxes LC and LD emitted from the third and fourth light sources 10c and 10d are converted into substantially parallel light fluxes in the main scanning cross section, and are condensed in the sub-scanning cross section by the third and fourth incident optical elements 20c and 20d.

Then, the third and fourth light fluxes LC and LD having passed through the third and fourth incident optical elements 20c and 20d pass through the third and fourth sub-scanning stops 30c and 30d, and the third and fourth main scanning stops 40c and 40d, and are then guided to a shared deflecting surface (second deflecting surface) 50b of the deflecting unit 50.

Thereby, the light flux diameters in the main scanning direction and the sub-scanning direction of the third and fourth light fluxes LC and LD are limited, and the third and fourth light fluxes LC and LD are condensed in the sub-scanning direction so as to form a line image long in the main scanning direction in the vicinity of the deflecting surface 50b of the deflecting unit 50.

In the light scanning apparatus 1 according to the present embodiment, the first and second light fluxes LA and LB emitted from the first and second light sources 10a and 10b are obliquely incident on the deflecting surface 50a of the deflecting unit 50 at different angles with respect to the main scanning cross section in the sub-scanning cross section.

Specifically, the first and second light fluxes LA and LB are obliquely incident on the deflecting surface 50a of the deflecting unit 50 at angles of −0.05 radian and +0.05 radian with respect to the main scanning cross section, respectively.

Further, the third and fourth light fluxes LC and LD emitted from the third and fourth light sources 10c and 10d are obliquely incident on the deflecting surface 50b of the deflecting unit 50 at different angles with respect to the main scanning cross section in the sub-scanning cross section.

Specifically, the third and fourth light fluxes LC and LD are obliquely incident on the deflecting surface 50b of the deflecting unit 50 at angles of −0.05 radian and +0.05 radian with respect to the main scanning cross section, respectively.

Next, the first and second light fluxes LA and LB deflected by the deflecting surface 50a of the deflecting unit 50 are condensed on the first and second scanned surfaces 100a and 100b by the first imaging optical element 60a, and the second imaging optical element 80a and 80b.

Further, the third and fourth light fluxes LC and LD deflected by the deflecting surface 50b of the deflecting unit 50 are condensed on the third and fourth scanned surfaces 100c and 100d by the first imaging optical element 60b, and the second imaging optical element 80c and 80d.

Then, as the deflecting unit 50 rotates, the first to fourth scanned surfaces 100a to 100d can be optically scanned with the first to fourth light fluxes LA to LD at a constant speed in the main scanning direction to record an image on the first to fourth scanned surfaces 100a to 100d.

In the light scanning apparatus 1 according to the present embodiment, a first incident optical system 75a is formed by the first incident optical element 20a, the first sub-scanning stop 30a and the first main scanning stop 40a.

A second incident optical system 75b is formed by the second incident optical element 20b, the second sub-scanning stop 30b and the second main scanning stop 40b. A third incident optical system 75c is formed by the third incident optical element 20c, the third sub-scanning stop 30c and the third main scanning stop 40c.

A fourth incident optical system 75d is formed by the fourth incident optical element 20d, the fourth sub-scanning stop 30d and the fourth main scanning stop 40d.

Further, in the light scanning apparatus 1 according to the present embodiment, a first imaging optical system 85a is formed by the first imaging optical element 60a and the second imaging optical element 80a, and a second imaging optical system 85b is formed by the first imaging optical element 60a and the second imaging optical element 80b.

A third imaging optical system 85c is formed by the first imaging optical element 60b and the second imaging optical element 80c, and a fourth imaging optical system 85d is formed by the first imaging optical element 60b and the second imaging optical element 80d.

FIGS. 3A and 3B show a partial developed view in the main scanning cross section and a partial sub-scanning cross sectional view of the light scanning apparatus 1 according to the present embodiment, respectively.

Specifically, FIG. 3A illustrates a synchronization detection optical system 95 in addition to the first and second incident optical systems 75a and 75b, and the first and second imaging optical systems 85a and 85b provided in the light scanning apparatus 1 according to the present embodiment.

Further, FIG. 3B illustrates the first and second imaging optical systems 85a and 85b, and the synchronization detection optical system 95.

Note that the first imaging optical element 60a is omitted, and the first and second light fluxes LA and LB are indicated by broken lines in order to clearly show the synchronization detection optical system 95, in FIG. 3B.

A direction (first direction) parallel to a straight line passing through a first intersecting point of the first scanned surface 100a and the optical axis of the first imaging optical system 85a and a second intersecting point of the second scanned surface 100b and the optical axis of the second imaging optical system 85b is considered.

At this time, as shown in FIG. 3B, the second scanned surface 100b is arranged between the deflecting unit 50 and the first scanned surface 100a in the direction.

In the light scanning apparatus 1 according to the present embodiment, in order to align scanning lines formed on the first to fourth scanned surfaces 100a to 100d with each other, writing start timings at which a light scanning is started on the first to fourth scanned surfaces 100a to 100d are synchronized with each other.

Then, in the light scanning apparatus 1 according to the present embodiment, the synchronization detection optical system 95 and the synchronization detection sensor 220 are provided to perform such synchronization.

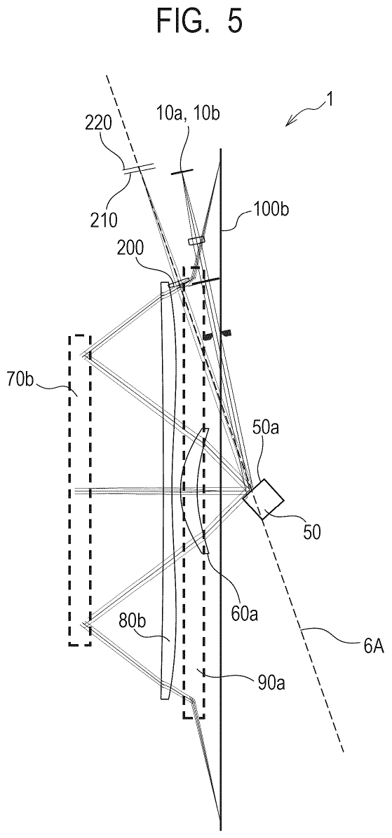

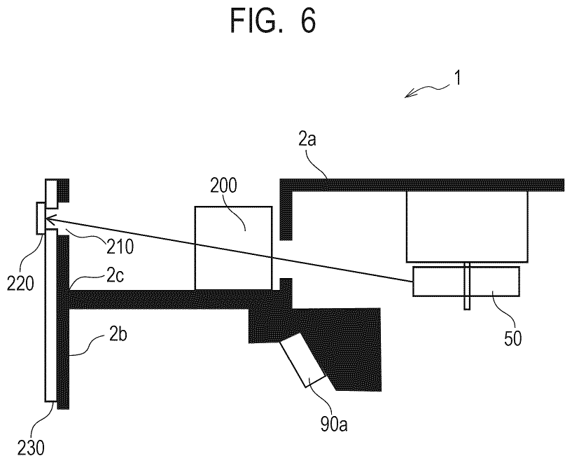

Specifically, the first light flux LA deflected in a predetermined direction by the deflecting surface 50a of the deflecting unit 50 is guided to the synchronization detection sensor 220 provided on the substrate 230 while being condensed in the main scanning direction by the synchronization detection lens 200 (see also FIGS. 5 and 6).

In other words, the synchronization detection sensor 220 receives the first light flux LA deflected by the deflecting surface 50a of the deflecting unit 50 without the first imaging optical system 85a.

By condensing the first light flux LA in the main scanning direction in the vicinity of the synchronization detection slit 210 by the synchronization detection lens 200 as described above, a waveform formed on the synchronization detection sensor 220 can be made steep.

Accordingly, it is possible to improve an accuracy of synchronization in the light scanning apparatus 1 according to the present embodiment.

Then, a controller (not shown) determines a light emission timing of each of the first to fourth light sources 10a to 10d by using a synchronization signal (a beam detection (BD) signal) obtained based on a signal output from the synchronization detection sensor 220.

In the light scanning apparatus 1 according to the present embodiment, the synchronization detection optical system 95 is formed by the synchronization detection lens 200 and the synchronization detection slit 210.

Next, Tables 1, 2, 3-1, 3-2 and 3-3 below show specification values, a refractive index and coordinates of each optical element, and shapes of optical surfaces of each optical element in the light scanning apparatus 1 according to the present embodiment.

Note that only the first and second incident optical systems 75a and 75b, the first and second imaging optical systems 85a and 85b, and the synchronization detection optical system 95 are shown in Tables 2, 3-1, 3-2 and 3-3.

That is, the third and fourth incident optical systems 75c and 75d and the third and fourth imaging optical systems 85c and 85d are omitted in Tables 2, 3-1, 3-2 and 3-3.

TABLE 1

| | Parameter | |
|---|---|---|
| Item | [Unit] | Value |
| Design wavelength of first to fourth light fluxes LA | λ [nm] | 790 |
| to LD from first to fourth light sources 10a to 10d | | |
| Scanning width of first to fourth scanned surface | W [mm] | 326 |
| 100a to 100d in main scanning direction | | |
| Distance between adjacent photosensitive drums | DP [mm] | 83 |
| Number of deflecting surfaces in deflecting unit 50 | [Surfaces] | 4 |
| Circumscribed diameter of deflecting unit 50 | Pd [mm] | 20 |
| Coordinates of rotation center of deflecting unit 50 | (X, Y) | (6.03, |
| | [mm] | −3.79) |
| Angle in main scanning cross section between | θim [rad] | 1.36 |
| optical axes of first to fourth incident optical | | |
| systems 75a to 75d and optical axes of first to | | |
| fourth imaging optical systems 85a to 85d | | |
| Absolute value of incident angle in sub-scanning | θis [rad] | 0.05 |
| cross section of first to fourth light fluxes LA | | |
| to LD to deflecting surfaces 50a and 50b of | | |
| deflecting unit 50 | | |
| Angle in main scanning cross section between | θbd [rad] | 1.24 |
| optical axis of synchronization detection optical | | |
| system 95 and optical axes of first and second | | |
| imaging optical systems 85a and 85b | | |
| Width in main scanning direction of opening portion | Am [mm] | 3.75 |
| of first to fourth main scanning stops 40a to 40d | | |
| Width in sub-scanning direction of opening portion | As [mm] | 2.70 |
| of first to fourth sub-scanning stops 30a to 30d | | |
| Focal length in main scanning cross section of | Fbd [mm] | 62.09 |
| synchronization detection lens 200 | | |
| Distance on optical axis between deflection point on | Dbd | 169.20 |
| deflecting surface of deflecting unit 50 and | [mm] | |
| synchronization detection sensor 220 | | |
| Distance in X direction between rotation center of | Xm [mm] | 34.13 |
| deflecting unit 50 and center of incident surface of | | |
| synchronization detection lens 200 | | |
| Distance in X direction between rotation center of | Xbd [mm] | 40.77 |
| deflecting unit 50 and center of incident surface of | | |
| second reflecting element 90a | | |

TABLE 2

| | Refractive | | | | | | |
|---|---|---|---|---|---|---|---|
| | index | Coordinates of surface vertex | | | Direction cosine of optical axis | | |
| Optical surface | (λ = 790 nm) | tc(x) | tc(y) | tc(z) | gx(x) | gx(y) | gx(z) |
| Light emitting | — | −33.58 | 157.99 | −7.62 | −0.21 | 0.98 | −0.05 |
| point of first | | | | | | | |
| light source 10a | | | | | | | |
| Incident surface | 1.53 | −26.61 | 125.17 | −6.03 | −0.21 | 0.98 | −0.05 |
| of first incident | | | | | | | |
| optical element | | | | | | | |
| 20a | | | | | | | |
| Exit surface of | — | −25.98 | 122.24 | −5.89 | −0.21 | 0.98 | −0.05 |
| first incident | | | | | | | |
| optical element | | | | | | | |
| 20a | | | | | | | |
| First sub- | — | −22.01 | 103.53 | −4.99 | −0.21 | 0.98 | 0.00 |
| scanning stop | | | | | | | |
| 30a | | | | | | | |
| First main | — | −16.63 | 78.25 | −3.77 | −0.21 | 0.98 | 0.00 |
| scanning stop | | | | | | | |
| 40a | | | | | | | |
| Deflecting | — | 0.53 | 0.66 | 0.00 | −0.78 | 0.63 | 0.00 |
| surface 50a of | | | | | | | |
| deflecting unit | | | | | | | |
| 50 (when | | | | | | | |
| scanning on- | | | | | | | |
| axis image | | | | | | | |
| height) | | | | | | | |
| Incident surface | 1.53 | −26.00 | 0.00 | 0.00 | −1.00 | 0.00 | 0.00 |
| of upper portion | | | | | | | |
| 60au of first | | | | | | | |
| imaging optical | | | | | | | |
| element | | | | | | | |
| Exit surface of | — | −34.20 | 0.00 | 0.00 | −1.00 | 0.00 | 0.00 |
| upper portion | | | | | | | |
| 60au of first | | | | | | | |
| imaging optical | | | | | | | |
| element | | | | | | | |
| Incident surface | 1.53 | −100.80 | 0.00 | 5.96 | −1.00 | 0.00 | 0.00 |
| of second | | | | | | | |
| imaging optical | | | | | | | |
| element 80a | | | | | | | |
| Exit surface of | — | −105.10 | 0.00 | 5.96 | −1.00 | 0.00 | 0.00 |
| second imaging | | | | | | | |
| optical element | | | | | | | |
| 80a | | | | | | | |
| Reflecting | — | −113.67 | 5.00 | 5.58 | −0.76 | 0.00 | 0.65 |
| surface of first | | | | | | | |
| reflecting | | | | | | | |
| element 70a | | | | | | | |
| First scanned | — | −97.70 | 0.00 | −112.69 | −0.15 | 0.00 | 0.99 |
| surface 100a | | | | | | | |
| Light emitting | — | −33.58 | 157.99 | 7.62 | −0.21 | 0.98 | 0.05 |
| point of second | | | | | | | |
| light source 10b | | | | | | | |
| Incident surface | 1.53 | −26.61 | 125.17 | 6.03 | −0.21 | 0.98 | 0.05 |
| of second | | | | | | | |
| incident optical | | | | | | | |
| element 20b | | | | | | | |
| Exit surface of | — | −25.98 | 122.24 | 5.89 | −0.21 | 0.98 | 0.05 |
| second incident | | | | | | | |
| optical element | | | | | | | |
| 20b | | | | | | | |
| Second sub- | — | −22.01 | 103.53 | 4.99 | −0.21 | 0.98 | 0.00 |
| scanning stop | | | | | | | |
| 30b | | | | | | | |
| Second main | — | −16.63 | 78.25 | 3.77 | −0.21 | 0.98 | 0.00 |
| scanning stop | | | | | | | |
| 40b | | | | | | | |
| Deflecting | — | 0.53 | 0.66 | 0.00 | −0.78 | 0.63 | 0.00 |
| surface 50a of | | | | | | | |
| deflecting unit | | | | | | | |
| 50 (when | | | | | | | |
| scanning on- | | | | | | | |
| axis image | | | | | | | |
| height) | | | | | | | |
| Incident surface | 1.53 | −26.00 | 0.00 | 0.00 | −1.00 | 0.00 | 0.00 |
| of lower portion | | | | | | | |
| 60al of first | | | | | | | |
| imaging optical | | | | | | | |
| element | | | | | | | |
| Exit surface of | — | −34.20 | 0.00 | 0.00 | −1.00 | 0.00 | 0.00 |
| lower portion | | | | | | | |
| 60al of first | | | | | | | |
| imaging optical | | | | | | | |
| element | | | | | | | |
| Incident surface | 1.53 | −42.87 | 0.00 | −15.46 | −0.99 | 0.00 | 0.16 |
| of second | | | | | | | |
| imaging optical | | | | | | | |
| element 80b | | | | | | | |
| Exit surface of | — | −38.63 | 0.00 | −16.15 | −0.99 | 0.00 | 0.16 |
| second imaging | | | | | | | |
| optical element | | | | | | | |
| 80b | | | | | | | |
| Reflecting | — | −81.82 | 0.00 | −4.68 | −1.00 | 0.00 | 0.08 |
| surface of first | | | | | | | |
| reflecting | | | | | | | |
| element 70b | | | | | | | |
| Reflecting | — | −28.10 | −4.50 | −17.47 | −0.70 | 0.00 | −0.71 |
| surface of | | | | | | | |
| second | | | | | | | |
| reflecting | | | | | | | |
| element 90a | | | | | | | |
| Second scanned | — | −14.70 | 0.00 | −112.69 | 0.17 | 0.00 | −0.99 |
| surface 100b | | | | | | | |
| Incident | 1.49 | −34.74 | 101.58 | 4.89 | −0.33 | 0.94 | 0.05 |
| surface of | | | | | | | |
| synchronization | | | | | | | |
| detection lens | | | | | | | |
| 200 | | | | | | | |
| Exit surface of | — | −35.39 | 103.46 | 4.99 | −0.33 | 0.94 | 0.05 |
| synchronization | | | | | | | |
| detection lens | | | | | | | |
| 200 | | | | | | | |
| Synchronization | — | −54.46 | 158.84 | 7.75 | −0.21 | 0.98 | 0.00 |
| detection slit | | | | | | | |
| 210 | | | | | | | |
| Synchronization | — | −55.11 | 160.72 | 7.84 | −0.21 | 0.98 | 0.00 |
| detection sensor | | | | | | | |
| 220 | | | | | | | |

TABLE 3-1

| | Aspherical surface coefficient | | | | | | |
|---|---|---|---|---|---|---|---|
| | | | | Upper portion 60au | | | |
| | | First incident | | of first imaging | | Second imaging | |
| | | optical element 20a | | optical element | | optical element 80a | |
| | | Incident | Exit | Incident | Exit | Incident | Exit |
| | Coefficient | surface | surface | surface | surface | surface | surface |
| Meridional | R | — | −3.72E+01 | −7.20E+01 | −4.32E+01 | 4.00E+03 | 3.46E+02 |
| line | K | — | — | 8.92E−01 | −5.73E−01 | — | −9.02E+01 |
| | B3 | — | — | — | — | — | — |
| | B4 | — | — | −7.61E−07 | −1.99E−07 | — | −2.17E−07 |
| | B5 | — | — | — | — | — | — |
| | B6 | — | — | 6.79E−09 | 1.64E−09 | — | 1.80E−11 |
| | B7 | — | — | — | — | — | — |
| | B8 | — | — | −5.89E−12 | 1.27E−12 | — | −1.07E−15 |
| | B9 | — | — | — | — | — | — |
| | B10 | — | — | 1.62E−15 | −1.42E−15 | — | 2.98E−20 |
| Sagittal | r | — | −2.62E+01 | 2.00E+01 | 2.06E+01 | 2.69E+01 | 2.94E+02 |
| line | E1 | — | — | — | — | — | 1.97E−07 |
| | E2 | — | — | — | 1.56E−05 | −5.14E−06 | −2.37E−06 |
| | E3 | — | — | — | — | — | −3.44E−09 |
| | E4 | — | — | — | −3.39E−08 | — | −2.47E−10 |
| | E5 | — | — | — | — | — | 1.50E−12 |
| | E6 | — | — | — | 3.96E−11 | — | 1.69E−14 |
| | E7 | — | — | — | — | — | −2.50E−16 |
| | E8 | — | — | — | −6.56E−14 | — | −1.80E−18 |
| | E9 | — | — | — | — | — | 1.41E−20 |
| | E10 | — | — | — | 5.40E−17 | — | 7.12E−23 |
| Additional | M0_1 | — | — | — | −3.93E−02 | −1.51E−01 | 1.07E−02 |
| term | M1_1 | — | — | — | — | −5.64E−06 | 2.98E−06 |
| | M2_1 | — | — | — | 3.68E−05 | −2.60E−05 | −4.00E−05 |
| | M3_1 | — | — | — | — | 1.31E−07 | 1.17E−07 |
| | M4_1 | — | — | — | — | 5.69E−09 | 7.91E−09 |
| | M5_1 | — | — | — | — | −3.83E−11 | −3.15E−11 |
| | M6_1 | — | — | — | — | 8.34E−14 | −6.67E−13 |
| | M7_1 | — | — | — | — | 5.13E−15 | 3.85E−15 |
| | M8_1 | — | — | — | — | −2.89E−17 | 8.31E−17 |
| | M9_1 | — | — | — | — | −2.20E−19 | −1.37E−19 |
| | M10_1 | — | — | — | — | −5.52E−22 | −5.82E−21 |
| | C3 | −8.67E−03 | — | — | — | — | — |
| | C5 | −7.85E−03 | — | — | — | — | — |

TABLE 3-2

| | Aspherical surface coefficient | | | | | | |
|---|---|---|---|---|---|---|---|
| | | | | Lower portion 60al | | | |
| | | Second incident | | of first imaging | | Second imaging | |
| | | optical element 20b | | optical element | | optical element 80b | |
| | | Incident | Exit | Incident | Exit | Incident | Exit |
| | Coefficient | surface | surface | surface | surface | surface | surface |
| Meridional | R | — | −3.72E+01 | −7.20E+01 | −4.43E+01 | 4.00E+03 | −3.84E+02 |
| line | K | — | — | 8.92E−01 | −1.16E+00 | — | −7.63E+01 |
| | B3 | — | — | — | — | — | — |
| | B4 | — | — | −7.61E−07 | −1.52E−06 | — | 1.34E−07 |
| | B5 | — | — | — | — | — | — |
| | B6 | — | — | 6.79E−09 | 1.75E−09 | — | −7.45E−12 |
| | B7 | — | — | — | — | — | — |
| | B8 | — | — | −5.89E−12 | 9.64E−13 | — | 3.30E−16 |
| | B9 | — | — | — | — | — | — |
| | B10 | — | — | 1.62E−15 | −1.20E−15 | — | −7.02E−21 |
| Sagittal | r | — | −2.62E+01 | 2.00E+01 | 5.46E+01 | −4.62E+01 | 1.10E+02 |
| line | E1 | — | — | — | — | — | 7.53E−07 |
| | E2 | — | — | — | 3.97E−06 | −5.27E−09 | −1.79E−06 |
| | E3 | — | — | — | — | — | 7.48E−10 |
| | E4 | — | — | — | 9.86E−08 | — | 2.81E−10 |
| | E5 | — | — | — | — | — | −1.82E−13 |
| | E6 | — | — | — | −2.89E−10 | — | −4.07E−14 |
| | E7 | — | — | — | — | — | 1.74E−17 |
| | E8 | — | — | — | 3.62E−13 | — | 3.25E−18 |
| | E9 | — | — | — | — | — | −5.09E−22 |
| | E10 | — | — | — | −1.62E−16 | — | −9.98E−23 |
| Additional | M0_1 | — | — | — | 1.14E−01 | −1.50E−01 | 7.95E−02 |
| term | M1_1 | — | — | — | — | −2.04E−05 | −1.32E−05 |
| | M2_1 | — | — | — | −5.07E−05 | −3.51E−08 | −1.55E−05 |
| | M3_1 | — | — | — | — | 4.84E−08 | 4.46E−08 |
| | M4_1 | — | — | — | — | −5.23E−10 | 1.81E−09 |
| | M5_1 | — | — | — | — | −1.02E−11 | −8.81E−12 |
| | M6_1 | — | — | — | — | 2.07E−13 | −1.66E−13 |
| | M7_1 | — | — | — | — | 9.45E−16 | 7.76E−16 |
| | M8_1 | — | — | — | — | −2.87E−18 | 2.43E−17 |
| | M9_1 | — | — | — | — | −2.86E−20 | −2.11E−20 |
| | M10_1 | — | — | — | — | 7.60E−23 | −4.80E−22 |
| | C3 | −8.67E−03 | — | — | — | — | — |
| | C5 | −7.85E−03 | — | — | — | — | — |

TABLE 3-3
Aspherical surface coefficient

| | Synchronization detection lens | |
|---|---|---|
| | 200 | |
| Coefficient | Incident surface | Exit surface |
| Curvature radius of | 3.01E+01 | — |
| meridional line R | | |
| Curvature radius of | 3.01E+01 | −4.59E+01 |
| sagittal line r | | |

Further, incident surfaces of the first to fourth incident optical elements 20a to 20d provided in the light scanning apparatus 1 according to the present embodiment are diffracting surfaces on which diffracting gratings are formed, and are formed by injection-molding with using a plastic material as described above.

For this reason, a so-called temperature compensation optical system is adopted in which changes in the refractive powers of the first to fourth incident optical elements 20a to 20d due to environmental variations are compensated for by changes in the diffractive powers of the diffracting surfaces associated with changes in the wavelengths of the first to fourth light fluxes LA to LD in the first to fourth light sources 10a to 10d.

Specifically, the diffracting surface formed on the incident surface of each of the first to fourth incident optical elements 20a to 20d is defined by a phase function expressed by the following Expression (1):

$$ϕ = \frac{2 π M}{λ} ( {C}_{3} {Z}^{2} \times {C}_{5} {Y}^{2} ) . \qquad ( 1 )$$

In Expression (1), q is a phase function, M is a diffraction order, λ is a design wavelength. Since first order diffraction light is used in the light scanning apparatus 1 according to the present embodiment, M is 1, and λ is 790 nm.

Further, a shape (a meridional shape) in the main scanning cross section of each of incident surfaces and exit surfaces of the first imaging optical elements 60a and 60b, and the second imaging optical elements 80a to 80d provided in the light scanning apparatus 1 according to the present embodiment has an aspheric shape represented by a tenth order polynomial function.

Specifically, an intersecting point (a surface vertex) of the optical surface and the optical axis of each of the first imaging optical elements 60a and 60b, and the second imaging optical elements 80a to 80d is set as the origin.

Further, the optical axis of each optical surface is defined as an X-axis, an axis perpendicular to the optical axis in the main scanning cross section is defined as a Y-axis, and an axis perpendicular to the optical axis in the sub-scanning cross section is defined as a Z-axis.

At this time, the aspheric shape in the main scanning cross section of each of the incident surfaces and the exit surfaces of the first imaging optical elements 60a and 60b, and the second imaging optical elements 80a to 80d is expressed by the following Expression (2):

$$X = \frac{\frac{{Y}^{2}}{R}}{1 + \sqrt{1 - ( 1 + K ) {( \frac{Y}{R} )}^{2}}} + {\sum }_{i = 1}^{10} {B}_{i} {Y}^{i} . \qquad ( 2 )$$

In Expression (2), R is a curvature radius (a curvature radius of meridional line) in the main scanning cross section, K is an eccentricity, and Bi is an aspheric coefficient.

Further, the shape (a sagittal shape) in the sub-scanning cross section of each of the incident surfaces and the exit surfaces of the first imaging optical elements 60a and 60b, and the second imaging optical elements 80a to 80d is represented by the following Expression (3):

$$S = \frac{\frac{{Z}^{2}}{{r}^{′}}}{1 + \sqrt{1 - {( \frac{Z}{{r}^{′}} )}^{2}}} + {\sum }_{i = 0}^{16} {\sum }_{j = 1}^{8} {M}_{i j} {Y}^{i} {Z}^{j} . \qquad ( 3 )$$

In Expression (3), S is a shape (a sagittal shape) in a cross section which includes a normal line of a meridional line at a predetermined position in the main scanning direction and is perpendicular to the main scanning cross section, and Mᵢⱼ is an aspheric coefficient.

Furthermore, a curvature radius (a curvature radius of sagittal line) r′ in the sub-scanning cross section at a position away from the optical axis by Y in the main scanning direction is represented by the following Expression (4):

$$\frac{1}{{r}^{′}} = \frac{1}{r} + {\sum }_{i = 1}^{10} {E}_{i} {Y}^{i} . \qquad ( 4 )$$

In Expression (4), r is the curvature radius of sagittal line on the optical axis, and Eᵢ is a sagittal change coefficient.

Although the shapes of the optical surfaces of the first imaging optical elements 60a and 60b, and the second imaging optical elements 80a to 80d provided in the light scanning apparatus 1 according to the present embodiment are defined by the functions represented by Expressions (1) to (4) described above, the present invention is not limited thereto, and the shapes may be defined by other functions.

As described above, in the light scanning apparatus 1 according to the present embodiment, the first and second light fluxes LA and LB pass through the shared first imaging optical element 60a, and the third and fourth light fluxes LC and LD pass through the shared first imaging optical element 60b.

Specifically, as shown in FIGS. 2A to 2C, the first and second light fluxes LA and LB pass through an upper portion 60au and a lower portion 60al in the sub-scanning direction of the first imaging optical element 60a, respectively.

Further, the third and fourth light fluxes LC and LD pass through an upper portion and a lower portion in the sub-scanning direction of the first imaging optical element 60b, respectively.

Note that the upper portion and the lower portion in the sub-scanning direction may be referred to a portion on a side opposite to the scanned surface in the sub-scanning direction, namely on an opposite scanned surface side, and a portion on a scanned surface side, respectively.

As shown in Tables 3-1 and 3-2, the shape of the exit surface of the first imaging optical element 60a is defined to be different between the upper portion 60au through which the first light flux LA passes and the lower portion 60al through which the second light flux LB passes.

That is, the first imaging optical element 60a is a single optical element, whereas is formed as a multistage configuration in which the shape of the exit surface is different between the upper portion 60au and the lower portion 60al in the sub-scanning direction, and the first imaging optical element 60b also has the same configuration.

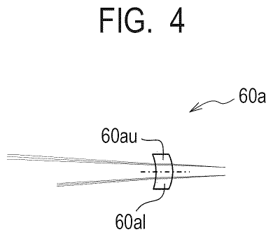

FIG. 4 shows a sub-scanning cross sectional view of the first imaging optical element 60a provided in the light scanning apparatus 1 according to the present embodiment.

As shown in FIG. 4, the first imaging optical element 60a has the upper portion 60au through which the first light flux LA passes and the lower portion 60al through which the second light flux LB passes, with a center line indicated by a broken line in the sub-scanning direction interposed therebetween.

Then, the upper portion 60au and the lower portion 60al of the first imaging optical element 60a have exit surfaces formed in the shapes shown in Table 3-1 and Table 3-2, respectively.

Thereby, both of the first and second light fluxes LA and LB emitted from the first and second light sources 10a and 10b can be efficiently condensed by the first imaging optical element 60a.

Next, folding of the optical paths of the first to fourth light fluxes LA to LD by the first reflecting elements 70a to 70d, and the second reflecting elements 90a and 90b in the light scanning apparatus 1 according to the present embodiment is described.

The optical paths of the second and third light fluxes LB and LC guided to the second and third scanned surfaces 100b and 100c arranged inside the first and fourth scanned surfaces 100a and 100d in the optical axis direction are folded by the two reflecting elements as shown in FIG. 2C.

Thereby, the optical paths and the optical path lengths of the first and fourth light fluxes LA and LD guided to the first and fourth scanned surfaces 100a and 100d can be matched with the optical paths and the optical path lengths of the second and third light fluxes LB and LC guided to the second and third scanned surfaces 100b and 100c.

Accordingly, it is possible to reduce a size in the sub-scanning direction of the housing 2 by using a minimum number of reflecting elements in the light scanning apparatus 1 according to the present embodiment.

Next, an arrangement of the synchronization detection optical system 95 in the light scanning apparatus 1 according to the present embodiment is described.

As described above, the synchronization between the first to fourth light sources 10a to 10d is performed by causing the synchronization detection sensor 220 to receive a part of the first light flux LA emitted from the first light source 10a in the light scanning apparatus 1 according to the present embodiment.

Here, the first light source 10a corresponds to the first scanned surface 100a which is arranged relatively outside in the X direction between the first and second scanned surfaces 100a and 100b.

That is, the light scanning apparatus 1 according to the present embodiment adopts a configuration in which the synchronization detection is performed by using a light flux emitted from a light source different from a light source corresponding to a scanned surface which is arranged relatively inside in the optical axis direction among a plurality of scanned surfaces.

In other words, the optical paths of the second and third light fluxes LB and LC on the inner side in the optical axis direction where a plurality of folds occur as described above and the optical path of the first light flux LA on the outer side in the optical axis direction where synchronization detection is performed are separately provided in the light scanning apparatus 1 according to the present embodiment.

Thereby, as shown in FIG. 3B, the second reflecting element 90a for folding the optical path of the second light flux LB on the inner side in the optical axis direction is arranged on the lower side in the sub-scanning direction with respect to the deflecting unit 50.

On the other hand, the synchronization detection lens 200 provided in the synchronization detection optical path in which a part of the first light flux LA deflected by the deflecting unit 50 travels is arranged above the deflecting unit 50 in the sub-scanning direction.

Therefore, the second reflecting element 90a and the synchronization detection lens 200 can be arranged to be away from each other in the sub-scanning direction.

Next, distances between the first to fourth scanned surfaces 100a to 100d in the light scanning apparatus 1 according to the present embodiment are described.

As shown in FIG. 2C, a distance DP between adjacent ones of the first to fourth photosensitive drums 100a to 100d forming the first to fourth scanned surfaces 100a to 100d, respectively, is a parameter directly linked to the size in the optical axis direction of the housing 2.

That is, as the distance DP between adjacent photosensitive drums becomes shorter, miniaturization in the optical axis direction of the housing 2 progresses, which is advantageous in a product such as an image forming apparatus in which the light scanning apparatus 1 according to the present embodiment is mounted.

Specifically, a distance between a first intersecting point of the first scanned surface 100a and the optical axis of the first imaging optical system 85a and a second intersecting point of the second scanned surface 100b and the optical axis of the second imaging optical system 85b is defined as DP.

Then, when scanning widths on the first and second scanned surfaces 100a and 100b are defined as W, it is preferred that the following inequality (5) is satisfied in the light scanning apparatus 1 according to the present embodiment:

$$0. 25 \leq DP / W \underline{<} 0 \text{.30} . \qquad ( 5 )$$

In the light scanning apparatus 1 according to the present embodiment, and the distance DP between adjacent photosensitive drums is set to 83 mm (DP/W=0.25) with setting the scanning width W in the main scanning direction to 326 mm so as to be compatible with an A3 size printing sheet, thereby achieving a reduction in the size of the housing 2.

On the other hand, it is necessary to pay attention to the arrangement of each optical element by shortening the distance DP between adjacent photosensitive drums in the light scanning apparatus 1 according to the present embodiment.

Specifically, it is necessary to arrange each optical element accommodated in the housing 2 at the center of the housing 2, namely close to the deflecting unit 50 in order to reduce the size in the optical axis direction of the housing 2.

FIG. 5 shows a partial projected view in the main scanning cross section of the light scanning apparatus 1 according to the present embodiment.

Specifically, FIG. 5 shows the optical path of the first light flux LA between the first light source 10a and the synchronization detection sensor 220, and the optical path of the second light flux LB between the second light source 10b and the second scanned surface 100b.

As shown in FIG. 5, when the distance DP between adjacent photosensitive drums is reduced in the light scanning apparatus 1 according to the present embodiment, the synchronization detection lens 200 and one end portion in the longitudinal direction of the second reflecting element 90a are arranged so as to be close to each other or partially overlap each other in the main scanning cross section.

Note that each of the reflecting elements provided in the light scanning apparatus 1 according to the present embodiment is supported by bringing both end portions in the longitudinal direction into contact with support portions (not shown) formed in the housing 2.

That is, the synchronization detection lens 200 and the support portion which supports one end portion in the longitudinal direction of the second reflecting element 90a are close to each other or partially overlap with each other in the main scanning cross section in the light scanning apparatus 1 according to the present embodiment.

In the light scanning apparatus 1 according to the present embodiment, the housing 2 has a box portion formed in a U-shape in the sub-scanning cross section, as shown in FIG. 2C.

Then, each optical element is inserted into the internal space of the box portion from the opened lower side in the sub-scanning direction of the housing 2, each optical element is supported by each support portion formed in the housing 2, and then the internal space is covered with a lid portion (not shown).

When the optical elements are inserted from the lower side in the sub-scanning direction which is open in the housing 2 as described above, it is very difficult to support the optical elements by the support portions at a plurality of positions which are the same in the main scanning cross section but are different from each other in the sub-scanning direction.

That is, when the distance DP between adjacent photosensitive drums is reduced in the light scanning apparatus 1 according to the present embodiment, it is difficult to arrange the synchronization detection lens 200 and the second reflecting element 90a on the same side with respect to a bottom surface 2a (a first surface) of the housing 2.

In other words, it is difficult to arrange both the synchronization detection lens 200 and the second reflecting element 90a on an inner side of the bottom surface 2a of the housing 2 in the light scanning apparatus 1 according to the present embodiment.

Accordingly, the light scanning apparatus 1 according to the present embodiment adopts a configuration in which the synchronization detection lens 200 is arranged in a region opposite to a region where the deflecting unit 50 and the second reflecting element 90a are arranged with respect to the bottom surface 2a of the housing 2.

In other words, the synchronization detection lens 200 and the deflecting unit 50 are arranged on one side and the other side of the bottom surface 2a of the housing 2, respectively, in the light scanning apparatus 1 according to the present embodiment.

In still other words, the synchronization detection lens 200 and the deflecting unit 50 are arranged on an outer side and an inner side of the bottom surface 2a of the housing 2, respectively, in the light scanning apparatus 1 according to the present embodiment.

FIG. 6 shows a partially enlarged view of the light scanning apparatus 1 according to the present embodiment in a 6A cross section perpendicular to the main scanning cross section shown in FIG. 5, and specifically, shows an enlarged view of it in the vicinity of the synchronization detection lens 200 in the 6A cross section.

As shown in FIG. 6, the synchronization detection lens 200 is arranged on a side opposite to the deflecting unit 50 with respect to the bottom surface 2a of the housing 2, namely on the outer side of the bottom surface 2a of the housing 2 in the light scanning apparatus 1 according to the present embodiment.

More specifically, the synchronization detection lens 200 is arranged in a concave portion formed on the bottom surface 2a of the housing 2 in the light scanning apparatus 1 according to the present embodiment.

That is, the bottom surface 2a of the housing 2 holds an upper surface of the synchronization detection lens 200.

In other words, the bottom surface 2a of the housing 2 provided in the light scanning apparatus 1 according to the present embodiment has a concave shape around the region where the synchronization detection lens 200 is arranged.

In still other words, the shape of the bottom surface 2a of the housing 2 provided in the light scanning apparatus 1 according to the present embodiment is not planer.

On the other hand, the second reflecting element 90a is arranged on the same side as the deflecting unit 50 with respect to the bottom surface 2a of the housing 2, namely on the inner side of the bottom surface 2a of the housing 2, in other words, in the internal space of the box portion of the housing 2.

Thereby, the synchronization detection lens 200 and the second reflecting element 90a can be arranged without physical interference by inserting them from opposite sides in the sub-scanning direction and bringing them into contact with the support portions, even if the support portion of the synchronization detection lens 200 and the support portion of the second reflecting element 90a overlap each other in the main scanning cross section.

Further, it is possible to reduce the influence of a temperature rise or dust caused by the rotation of the deflecting unit 50 on the synchronization detection lens 200 by separating the region where the synchronization detection lens 200 is arranged and the region where the deflecting unit 50 is separated from each other with the bottom surface 2a of the housing 2 interposed therebetween.

Therefore, it is possible to suppress a decrease in synchronization detection performance in the light scanning apparatus 1 according to the present embodiment.

In the light scanning apparatus 1 according to the present embodiment, it is possible to achieve both the shortening of the distance DP between adjacent photosensitive drums and the mounting of the synchronization detection optical system 95 by adopting the above-described configuration to devise a method of mounting the synchronization detection lens 200.

Further, in the light scanning apparatus 1 according to the present embodiment, the synchronization detection sensor 220 is arranged on an outer side of a side surface 2b (a second surface) of the housing 2, and the synchronization detection slit 210 is formed integrally with the side surface 2b of the housing 2, namely in the side surface 2b of the housing 2, as shown in FIG. 6.

Note that the bottom surface 2a and the side surface 2b are integrally coupled with each other at a portion 2c in the housing 2, as shown in FIG. 6.

As shown in FIG. 6, the first light flux LA deflected in a predetermined direction by the deflecting unit 50 exits to the outer side of the bottom surface 2a of the housing 2 by passing through an opening portion formed in a predetermined wall surface of the concave portion of the bottom surface 2a of the housing 2, and then is incident on the synchronization detection lens 200.

Then, the first light flux LA that has passed through the synchronization detection lens 200 is incident on the synchronization detection sensor 220 by passing through the synchronization detection slit 210.

Next, the shape of each of the second imaging optical elements 80a to 80d provided in the light scanning apparatus 1 according to the present embodiment is described.

As described above, the second imaging optical element 80a for guiding the first light flux LA to the first scanned surface 100a and the second imaging optical element 80b for guiding the second light flux LB to the second scanned surface 100b have shapes different from each other, and are arranged at positions optically asymmetric to each other.

That is, the second imaging optical elements 80a to 80d are formed in different shapes from each other in the light scanning apparatus 1 according to the present embodiment.

Thereby, the first to fourth light fluxes LA to LD guided by the first to fourth imaging optical systems 85a to 85d different from each other can be suitably condensed on the first to fourth scanned surfaces 100a to 100d.

However, the present invention is not limited to this, and it is possible to obtain the effect of the present embodiment, even if the second imaging optical elements 80a and 80b are formed in the same shape as each other and are arranged at positions optically symmetrical to each other, for example.

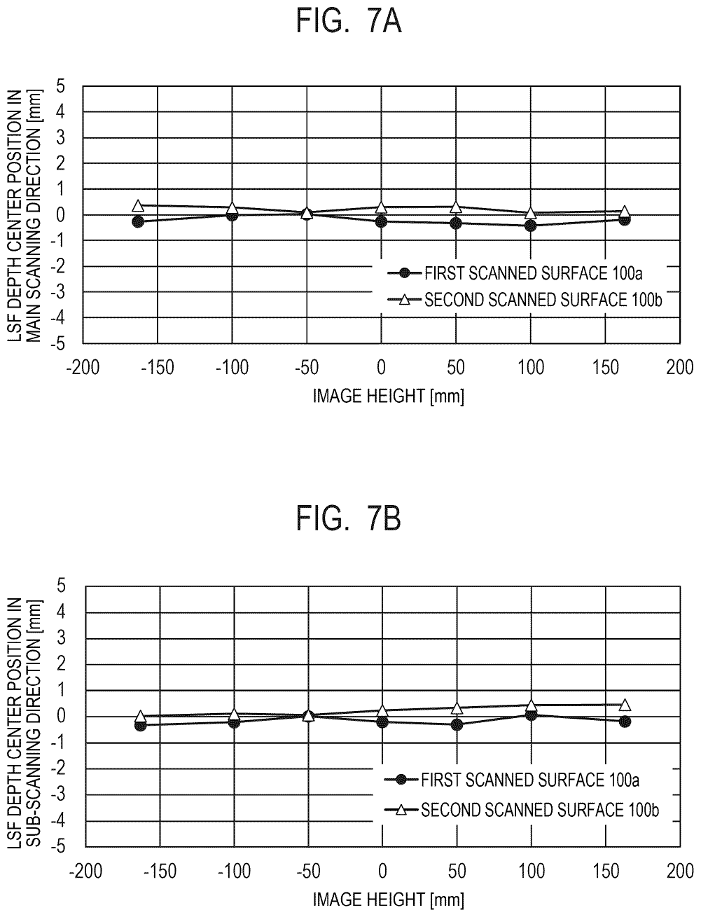

FIGS. 7A and 7B show image height dependencies of a LSF (Line Spread Function) depth center position in the main scanning direction and a LSF depth center position in the sub-scanning direction on each scanned surface in the light scanning apparatus 1 according to the present embodiment, respectively.

Note that the LSF depth center position in the main scanning direction and the LSF depth center position in the sub-scanning direction refer to center positions of regions in which the LSF widths in the main scanning direction and the sub-scanning direction are equal to or less than a slice level when defocusing is performed in the optical axis direction in the vicinity of a predetermined scanned surface, respectively.

In the light scanning apparatus 1 according to the present embodiment, the slice level is set to 120 μm over the entire image height in both the main scanning direction and the sub-scanning direction.

In addition, the LSF width in the main scanning direction and the LSF width in the sub-scanning direction indicate widths when light amount profiles obtained by integrating a spot profile in the sub-scanning direction and the main scanning direction at each image height are sliced at a position of 13.5% of the maximum value, respectively.

As shown in FIGS. 7A and 7B, both of the LSF depth center position in the main scanning direction and the LSF depth center position in the sub-scanning direction are within the range of +1 mm over the entire image height, so that it can be seen that the light scanning apparatus 1 according to the present embodiment achieves a favorable imaging performance.

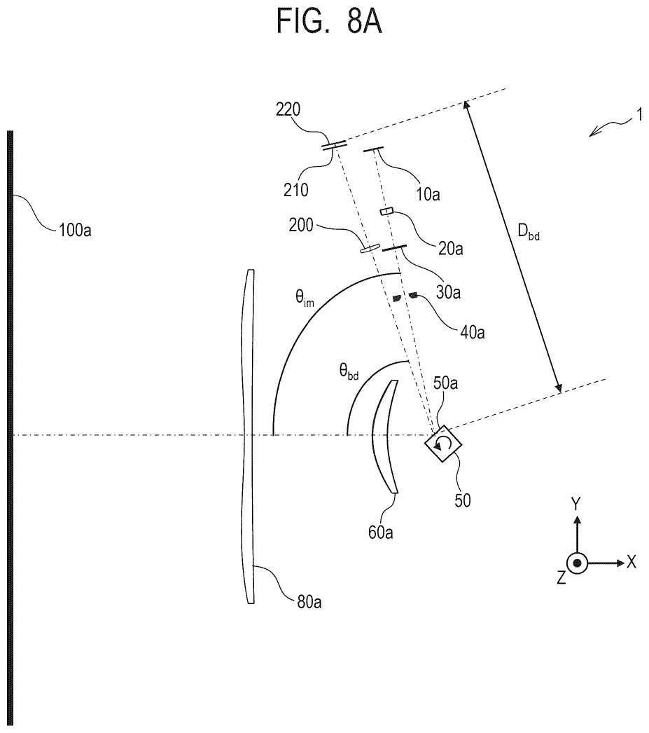

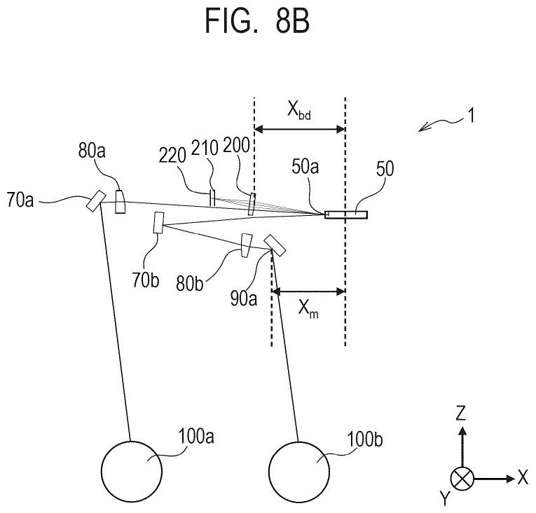

FIGS. 8A and 8B show a partial developed view in the main scanning cross section and a partial sub-scanning cross sectional view for explaining each inequality in the light scanning apparatus 1 according to the present embodiment, respectively.

First, an angle (an acute angle) formed by the optical axis of the first incident optical system 75a and the optical axis of the first imaging optical system 85a when they are projected in the main scanning cross section is defined as θᵢₘ (radian).

At this time, it is preferred that the following inequality (6) is satisfied in the light scanning apparatus 1 according to the present embodiment:

$$1. 00 < {θ}_{i m} < 1.5 . \qquad ( 6 )$$

When the value exceeds the upper limit value in the inequality (6), vignetting in the deflecting unit 50 is likely to occur, and if the position of the first light source 10a is shifted in order to suppress the vignetting, the optical characteristics are likely to deteriorate.

On the other hand, when the value falls below the lower limit value in the inequality (6), the first incident optical system 75a and the first imaging optical system 85a are likely to interfere with each other.

In the light scanning apparatus 1 according to the present embodiment, it is more preferred that the following inequality (6a) is satisfied:

$$1.2 < {θ}_{i m} < 1.5 . \qquad ( 6 a )$$

In the light scanning apparatus 1 according to the present embodiment, θᵢₘ is 1.36 as shown in Table 1, so that the inequalities (6) and (6a) are satisfied.

Further, an angle (an acute angle) formed by the optical axis of the synchronization detection optical system 95 and the optical axis of the first imaging optical system 85a when they are projected in the main scanning cross section is defined as θ_{bd} (radian).

At this time, it is preferred that the following inequality (7) is satisfied in the light scanning apparatus 1 according to the present embodiment:

$$0.8 < {θ}_{b d} / {θ}_{i m} < 0 \text{.95} . \qquad ( 7 )$$

When the ratio exceeds the upper limit value in the inequality (7), the synchronization detection optical system 95 becomes too close to the first incident optical system 75a.

Therefore, the first light flux LA guided by the synchronization detection optical system 95 and the first light flux LA guided by the first incident optical system 75a are likely to interfere with each other.

On the other hand, when the ratio falls below the lower limit value in the inequality (7), the synchronization detection optical system 95 becomes too close to the first imaging optical system 85a.

Therefore, the first light flux LA guided by the synchronization detection optical system 95 and the first light flux LA guided by the first imaging optical system 85a are likely to interfere with each other.

In the light scanning apparatus 1 according to the present embodiment, it is more preferred that the following inequality (7a) is satisfied:

$$0.84 < {θ}_{b d} / {θ}_{i m} < 0 \text{.95} . \qquad ( 7 a )$$

In the light scanning apparatus 1 according to the present embodiment, θ_{bd}/θᵢₘ is 0.91 as shown in Table 1, so that the inequalities (7) and (7a) are satisfied.

Further, a distance on the optical axis of the synchronization detection optical system 95 between the synchronization detection sensor 220 and a deflection point on the deflecting surface 50a of a principal ray of the first light flux LA deflected in a predetermined direction by the deflecting unit 50 so as to reach the synchronization detection sensor 220 is defined as D_{bd}.

That is, the distance D_{bd} is a distance between the deflection point on the deflecting surface 50a of the principal ray of the first light flux LA guided by the synchronization detection optical system 95 to an intersecting point of the optical axis of the synchronization detection optical system 95 and a light receiving surface of the synchronization detection sensor 220, and the intersecting point.

Then, when a focal length in the main scanning cross section of the synchronization detection lens 200 is defined as F_{bd}, it is preferred that the following inequality (8) is satisfied in the light scanning apparatus 1 according to the present embodiment:

$$0.3 < {F}_{b d} / {D}_{b d} < 0 \text{.70} . \qquad ( 8 )$$

When the ratio exceeds the upper limit value in the inequality (8), the synchronization detection lens 200 becomes too close to the deflecting unit 50.

Therefore, the first light flux LA guided by the synchronization detection optical system 95 is likely to interfere with the first light flux LA guided by the first incident optical system 75a, and the first light flux LA guided by the first imaging optical system 85a.

On the other hand, when the ratio falls below the lower limit value in the inequality (8), the focal length F_{bd} in the main scanning cross section of the synchronization detection lens 200 becomes too short, so that an optical sensitivity increases.

In the light scanning apparatus 1 according to the present embodiment, it is more preferred that the following inequality (8a) is satisfied:

$$0.3 < {F}_{b d} / {D}_{b d} < 0 \text{.50} . \qquad ( 8 a )$$

In the light scanning apparatus 1 according to the present embodiment, F_{bd}/D_{bd} is 0.37 as shown in Table 1, so that the inequalities (8) and (8a) are satisfied.

Further, a direction parallel to a straight line passing through a first intersecting point of the first scanned surface 100a and the optical axis of the first imaging optical system 85a and a second intersecting point of the second scanned surface 100b and the optical axis of the second imaging optical system 85b is defined.

Then, a distance between the rotation center of the deflecting unit 50 and a center of an incident surface of the synchronization detection lens 200 in this direction is defined as X_{bd}.

A distance between the rotation center of the deflecting unit 50 and a center of an incident surface of a predetermined optical element arranged closest to the deflecting unit 50 among imaging optical elements and reflecting elements provided on the optical paths of the first and second light fluxes LA and LB in this direction is defined as Xₘ.

At this time, it is preferred that the following inequality (9) is satisfied in the light scanning apparatus 1 according to the present embodiment:

$$0.6 < {X}_{m} / {X}_{b d} < 1.5 . \qquad ( 9 )$$

When the ratio exceeds the upper limit value in the inequality (9), the imaging optical elements and the reflecting elements provided on the optical paths of the first and second light fluxes LA and LB become too far away from the deflecting unit 50, which makes it difficult to shorten the distance DP between the first and second photosensitive drums 100a and 100b.

On the other hand, when the ratio falls below the lower limit value in the inequality (9), a predetermined optical element included in the imaging optical element and the reflecting element provided on the optical paths of the first and second light fluxes LA and LB becomes too close to the deflecting unit 50, which may increase the size in the sub-scanning direction of the housing 2.

In addition, When the ratio falls below the lower limit value in the inequality (9), the predetermined optical element is likely to interfere with imaging optical elements and reflecting elements, which are provided on the opposite side with respect to the deflecting unit 50 and through which the third and fourth light fluxes LC and LD pass.

In the light scanning apparatus 1 according to the present embodiment, it is more preferred that the following inequality (9a) is satisfied:

$$0.7 < {X}_{m} / {X}_{b d} < 1.2 . \qquad ( 9 a )$$

In the light scanning apparatus 1 according to the present embodiment, the optical element arranged closest to the deflecting unit 50 is the second reflecting element 90a among the imaging optical elements and the reflecting elements provided on the optical paths of the first and second light fluxes LA and LB.

Therefore, Xₘ/X_{bd} is 0.84 as shown in Table 1, so that the inequalities (9) and (9a) are satisfied.

As described above, in the light scanning apparatus 1 according to the present embodiment, the deflecting unit 50 and the synchronization detection lens 200 are provided on sides opposite to each other with respect to the bottom surface 2a of the housing 2.

Thereby, it is possible to reduce the size in the direction perpendicular to each of the main scanning direction and the sub-scanning direction, namely in the optical axis directions of the first to fourth imaging optical systems 85a to 85d in the light scanning apparatus 1 according to the present embodiment.

### Second Embodiment

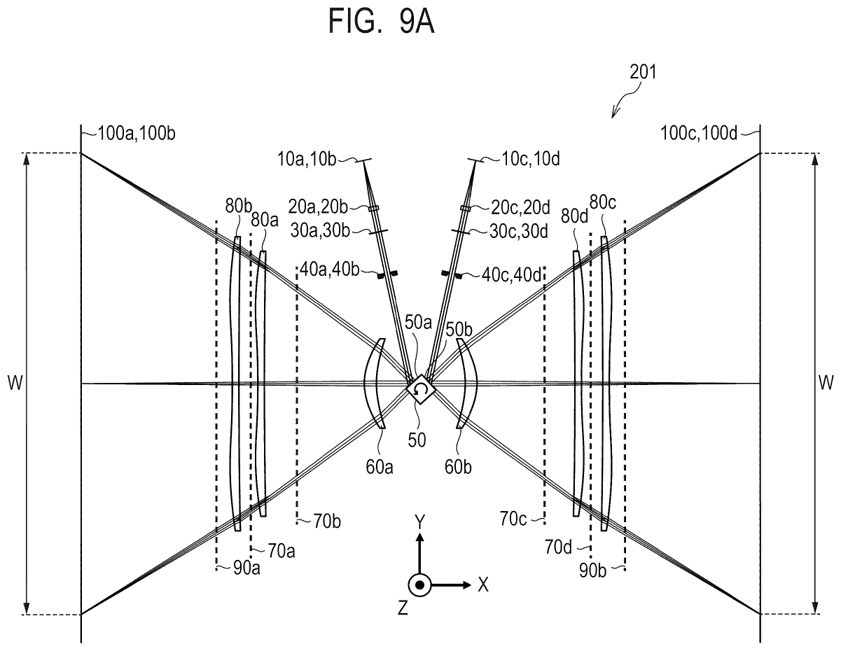

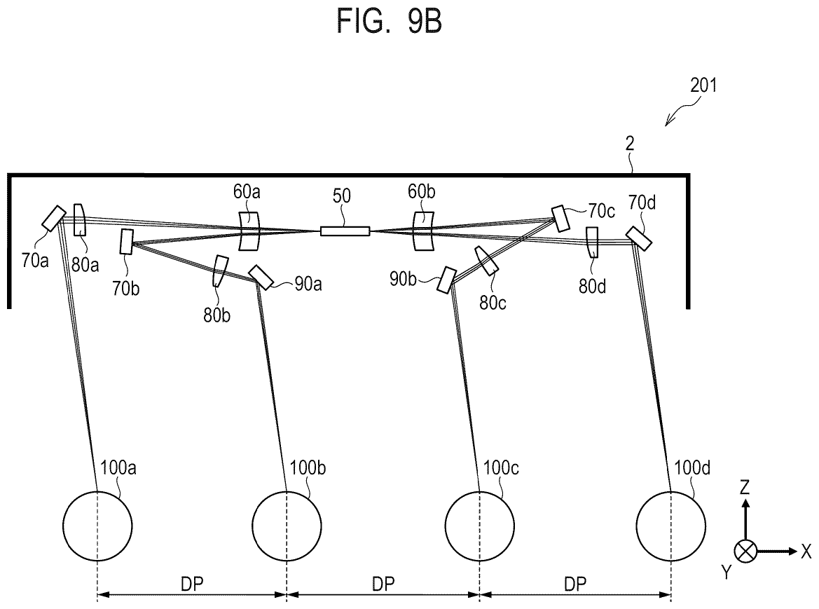

FIGS. 9A and 9B show a partial developed view in the main scanning cross section (corresponding to FIGS. 1A and 1B) and a partial sub-scanning cross sectional view (corresponding to FIG. 2C) of a light scanning apparatus 201 according to a second embodiment of the present invention, respectively.

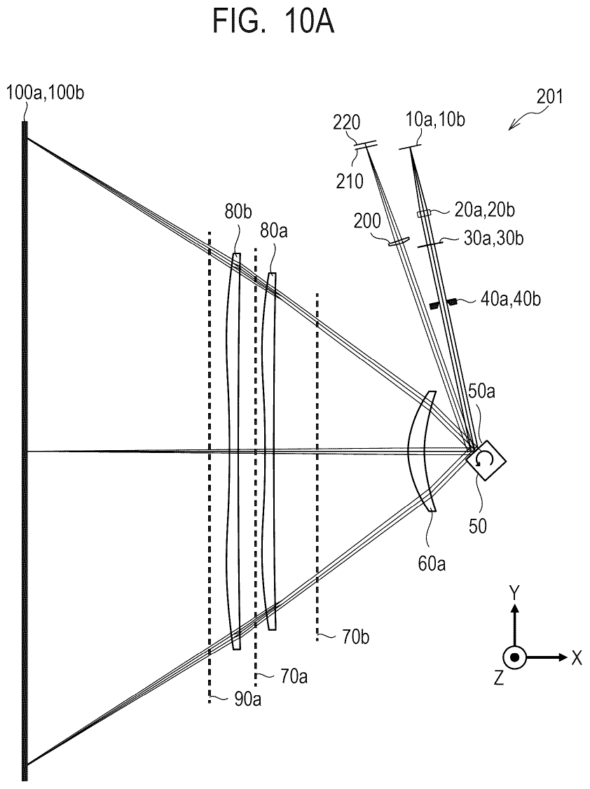

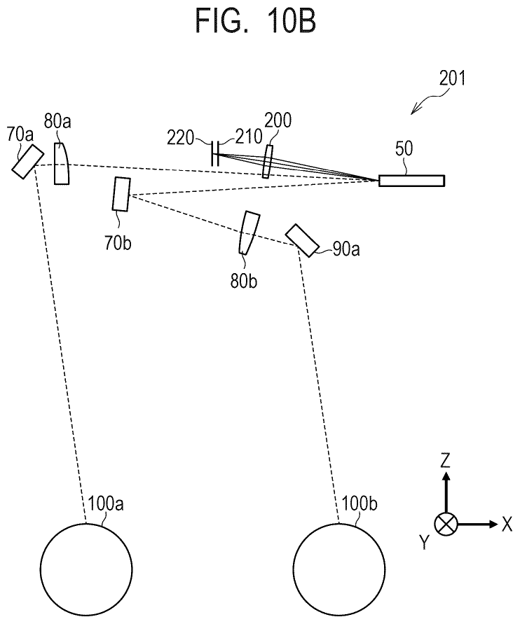

Further, FIGS. 10A and 10B show a partial developed view in the main scanning cross section (corresponding to FIG. 3A) and a partial sub-scanning cross sectional view (corresponding to FIG. 3B) of the light scanning apparatus 201 according to the second embodiment, respectively.

Note that the light scanning apparatus 201 according to the present embodiment has the same configuration as that of the light scanning apparatus 1 according to the first embodiment except that numerical values are different, so that the same members are denoted by the same reference numerals, and description thereof is omitted.

In addition, Tables 4, 5, 6-1, 6-2 and 6-3 below show the specification values, a refractive index and coordinates of each optical element, and shapes of optical surfaces of each optical element in the light scanning apparatus 201 according to the present embodiment.

Note that Tables 5, 6-1, 6-2 and 6-3 show only the first and second incident optical systems 75a and 75b, the first and second imaging optical systems 85a and 85b, and the synchronization detection optical system 95.

That is, the third and fourth incident optical systems 75c and 75d, and the third and fourth imaging optical systems 85c and 85d are omitted in Tables 5, 6-1, 6-2 and 6-3.

TABLE 4

| | Parameter | |
|---|---|---|
| Item | [Unit] | Value |
| Design wavelength of first to fourth light | λ [nm] | 790 |
| fluxes LA to LD from first to fourth light sources | | |
| 10a to 10d | | |
| Scanning width of first to fourth scanned surface | W [mm] | 326 |
| 100a to 100d in main scanning direction | | |
| Distance between adjacent photosensitive drums | DP [mm] | 83 |
| Number of deflecting surfaces in deflecting | [Surfaces] | 4 |
| unit 50 | | |
| Circumscribed diameter of deflecting unit 50 | Pd [mm] | 20 |
| Coordinates of rotation center of deflecting | (X, Y) | (6.03, |
| unit 50 | [mm] | −3.79) |
| Angle in main scanning cross section between | θim [rad] | 1.36 |
| optical axes of first to fourth incident optical | | |
| systems 75a to 75d and optical axes of first to | | |
| fourth imaging optical systems 85a to 85d | | |
| Absolute value of incident angle in sub-scanning | θis [rad] | 0.05 |
| cross section of first to fourth light fluxes LA to | | |
| LD to deflecting surfaces 50a and 50b of | | |
| deflecting unit 50 | | |
| Angle in main scanning cross section between | θbd [rad] | 1.20 |
| optical axis of synchronization detection optical | | |
| system 95 and optical axes of first and second | | |
| imaging optical systems 85a and 85b | | |
| Width in main scanning direction of opening | Am [mm] | 3.75 |
| portion of first to fourth main scanning stops | | |
| 40a to 40d | | |
| Width in sub-scanning direction of opening | As [mm] | 2.84 |
| portion of first to fourth sub-scanning stops | | |
| 30a to 30d | | |
| Focal length in main scanning cross | Fbd [mm] | 53.58 |
| section of synchronization detection lens 200 | | |
| Distance on optical axis between deflection point | Dbd [mm] | 169.20 |
| on deflecting surface of deflecting unit 50 and | | |
| synchronization detection sensor 220 | | |
| Distance in X direction between rotation center | Xm [mm] | 33.58 |
| of deflecting unit 50 and center of incident | | |
| surface of synchronization detection lens 200 | | |
| Distance in X direction between rotation center | Xbd [mm] | 43.37 |
| of deflecting unit 50 and center of incident | | |
| surface of second reflecting element 90a | | |

TABLE 5

| | Refractive | | | | | | |
|---|---|---|---|---|---|---|---|
| | index | Coordinates of surface vertex | | | Direction cosine of optical axis | | |
| Optical surface | (λ = 790 nm) | tc(x) | tc(y) | tc(z) | gx(x) | tc(x) | tc(y) |
| Light emitting | — | −33.58 | 157.99 | −7.62 | −0.21 | 0.98 | −0.05 |
| point of first | | | | | | | |
| light source 10a | | | | | | | |
| Incident surface | 1.53 | −26.61 | 125.17 | −6.03 | −0.21 | 0.98 | −0.05 |
| of first incident | | | | | | | |
| optical element | | | | | | | |
| 20a | | | | | | | |
| Exit surface of | — | −25.98 | 122.24 | −5.89 | −0.21 | 0.98 | −0.05 |
| first incident | | | | | | | |
| optical element | | | | | | | |
| 20a | | | | | | | |
| First sub- | — | −22.84 | 107.44 | −5.18 | −0.21 | 0.98 | 0.00 |
| scanning stop | | | | | | | |
| 30a | | | | | | | |
| First main | — | −16.63 | 78.25 | −3.77 | −0.21 | 0.98 | 0.00 |
| scanning stop | | | | | | | |
| 40a | | | | | | | |
| Deflecting | — | 0.53 | 0.66 | 0.00 | −0.78 | 0.63 | 0.00 |
| surface 50a of | | | | | | | |
| deflecting unit | | | | | | | |
| 50 (when | | | | | | | |
| scanning on- | | | | | | | |
| axis image | | | | | | | |
| height) | | | | | | | |
| Incident surface | 1.53 | −26.00 | 0.00 | 0.00 | −1.00 | 0.00 | 0.00 |
| of upper portion | | | | | | | |
| 60au of first | | | | | | | |
| imaging optical | | | | | | | |
| element | | | | | | | |
| Exit surface of | — | −34.20 | 0.00 | 0.00 | −1.00 | 0.00 | 0.00 |
| upper portion | | | | | | | |
| 60au of first | | | | | | | |
| imaging optical | | | | | | | |
| element | | | | | | | |
| Incident surface | 1.53 | −103.50 | 0.00 | 5.03 | −1.00 | 0.00 | 0.00 |
| of second | | | | | | | |
| imaging optical | | | | | | | |
| element 80a | | | | | | | |
| Exit surface of | — | −107.80 | 0.00 | 5.03 | −1.00 | 0.00 | 0.00 |
| second imaging | | | | | | | |
| optical element | | | | | | | |
| 80a | | | | | | | |
| Reflecting | — | −114.19 | 5.00 | 4.98 | −0.76 | 0.00 | 0.65 |
| surface of first | | | | | | | |
| reflecting | | | | | | | |
| element 70a | | | | | | | |
| First scanned | — | −97.70 | 0.00 | −112.69 | −0.15 | 0.00 | 0.99 |
| surface 100a | | | | | | | |
| Light emitting | — | −33.58 | 157.99 | 7.62 | −0.21 | 0.98 | 0.05 |
| point of second | | | | | | | |
| light source 10b | | | | | | | |
| Incident surface | 1.53 | −26.61 | 125.17 | 6.03 | −0.21 | 0.98 | 0.05 |
| of second | | | | | | | |
| incident optical | | | | | | | |
| element 20b | | | | | | | |
| Exit surface of | — | −25.98 | 122.24 | 5.89 | −0.21 | 0.98 | 0.05 |
| second incident | | | | | | | |
| optical element | | | | | | | |
| 20b | | | | | | | |
| Second sub- | — | −22.84 | 107.44 | 5.18 | −0.21 | 0.98 | 0.00 |
| scanning stop | | | | | | | |
| 30b | | | | | | | |
| Second main | — | −16.63 | 78.25 | 3.77 | −0.21 | 0.98 | 0.00 |
| scanning stop | | | | | | | |
| 40b | | | | | | | |
| Deflecting | — | 0.53 | 0.66 | 0.00 | −0.78 | 0.63 | 0.00 |
| surface 50a of | | | | | | | |
| deflecting unit | | | | | | | |
| 50 (when | | | | | | | |
| scanning on- | | | | | | | |
| axis image | | | | | | | |
| height) | | | | | | | |
| Incident surface | 1.53 | −26.00 | 0.00 | 0.00 | −1.00 | 0.00 | 0.00 |
| of lower portion | | | | | | | |
| 60al of first | | | | | | | |
| imaging optical | | | | | | | |
| element | | | | | | | |
| Exit surface of | — | −34.20 | 0.00 | 0.00 | −1.00 | 0.00 | 0.00 |
| lower portion | | | | | | | |
| 60al of first | | | | | | | |
| imaging optical | | | | | | | |
| element | | | | | | | |
| Incident surface | 1.53 | −46.37 | 0.00 | −17.30 | −0.97 | 0.00 | 0.26 |
| of second | | | | | | | |
| imaging optical | | | | | | | |
| element 80b | | | | | | | |
| Exit surface of | — | −42.22 | 0.00 | −18.43 | −0.97 | 0.00 | 0.26 |
| second imaging | | | | | | | |
| optical element | | | | | | | |
| 80b | | | | | | | |
| Reflecting | — | −83.25 | 0.00 | −5.28 | −0.99 | 0.00 | 0.13 |
| surface of first | | | | | | | |
| reflecting | | | | | | | |
| element 70b | | | | | | | |
| Reflecting | — | −27.55 | −3.50 | −21.93 | −0.74 | 0.00 | −0.67 |
| surface of | | | | | | | |
| second | | | | | | | |
| reflecting | | | | | | | |
| element 90a | | | | | | | |
| Second scanned | — | −14.70 | 0.00 | −112.69 | 0.17 | 0.00 | −0.99 |
| surface 100b | | | | | | | |
| Incident | 1.49 | −37.34 | 109.13 | 5.27 | −0.33 | 0.94 | 0.05 |
| surface of | | | | | | | |
| synchronization | | | | | | | |
| detection lens | | | | | | | |
| 200 | | | | | | | |
| Exit surface of | — | −37.99 | 111.02 | 5.36 | −0.33 | 0.94 | 0.05 |
| synchronization | | | | | | | |
| detection lens | | | | | | | |
| 200 | | | | | | | |
| Synchronization | — | −54.46 | 158.84 | 7.75 | −0.21 | 0.98 | 0.00 |
| detection slit | | | | | | | |
| 210 | | | | | | | |
| Synchronization | — | −55.11 | 160.72 | 7.84 | −0.21 | 0.98 | 0.00 |
| detection sensor | | | | | | | |
| 220 | | | | | | | |

TABLE 6-1

| | Aspherical surface coefficient | | | | | | |
|---|---|---|---|---|---|---|---|
| | | | | Upper portion 60au | | | |
| | | First incident | | of first imaging | | Second imaging | |
| | | optical element 20a | | optical element | | optical element 80a | |
| | | Incident | Exit | Incident | Exit | Incident | Exit |
| | Coefficient | surface | surface | surface | surface | surface | surface |
| Meridional | R | — | −3.72E+01 | −7.11E+01 | −4.29E+01 | 4.00E+03 | 3.50E+02 |
| line | K | — | — | 9.46E−01 | −5.15E−01 | — | −8.75E+01 |
| | B3 | — | — | — | — | — | — |
| | B4 | — | — | −9.15E−07 | −3.48E−07 | — | −2.02E−07 |
| | B5 | — | — | — | — | — | — |
| | B6 | — | — | 6.78E−09 | 1.69E−09 | — | 1.61E−11 |
| | B7 | — | — | — | — | — | — |
| | B8 | — | — | −5.77E−12 | 1.11E−12 | — | −9.31E−16 |
| | B9 | — | — | — | — | — | — |
| | B10 | — | — | 1.64E−15 | −1.22E−15 | — | 2.52E−20 |
| Sagittal | r | — | −2.62E+01 | 2.00E+01 | 2.50E+01 | 3.71E+01 | −1.54E+02 |
| line | E1 | — | — | — | — | — | −1.28E−07 |
| | E2 | — | — | — | 1.52E−05 | −7.46E−07 | 1.81E−06 |
| | E3 | — | — | — | — | — | −3.24E−09 |
| | E4 | — | — | — | 8.49E−10 | — | −3.04E−10 |
| | E5 | — | — | — | — | — | 1.34E−12 |
| | E6 | — | — | — | −2.51E−11 | — | 3.08E−14 |
| | E7 | — | — | — | — | — | −2.01E−16 |
| | E8 | — | — | — | 7.61E−15 | — | −1.95E−18 |
| | E9 | — | — | — | — | — | 9.86E−21 |
| | E10 | — | — | — | 1.61E−17 | — | 5.81E−23 |
| Additional | M0_1 | — | — | — | −2.12E−02 | −1.01E−01 | 2.32E−02 |
| term | M1_1 | — | — | — | — | −2.13E−04 | −2.00E−04 |
| | M2_1 | — | — | — | 3.32E−05 | −1.31E−05 | −2.37E−05 |
| | M3_1 | — | — | — | — | 1.16E−07 | 1.06E−07 |
| | M4_1 | — | — | — | — | 1.77E−09 | 3.67E−09 |
| | M5_1 | — | — | — | — | −1.62E−11 | −1.41E−11 |
| | M6_1 | — | — | — | — | 3.01E−13 | −3.05E−13 |
| | M7_1 | — | — | — | — | 1.06E−15 | 9.73E−16 |
| | M8_1 | — | — | — | — | −1.31E−17 | 6.57E−17 |
| | M9_1 | — | — | — | — | −1.66E−20 | −1.73E−20 |
| | M10_1 | — | — | — | — | −8.54E−22 | −3.96E−21 |
| | C3 | −8.67E−03 | — | — | — | — | — |
| | C5 | −7.85E−03 | — | — | — | — | — |

TABLE 6-2

| | Aspherical surface coefficient | | | | | | |
|---|---|---|---|---|---|---|---|
| | | | | Lower portion 60al | | | |
| | | Second incident | | of first imaging | | Second imaging | |
| | | optical element 20b | | optical element | | optical element 80b | |
| | | Incident | Exit | Incident | Exit | Incident | Exit |
| | Coefficient | surface | surface | surface | surface | surface | surface |
| Meridional | R | — | −3.72E+01 | −7.11E+01 | −4.38E+01 | 4.00E+03 | −3.80E+02 |
| line | K | — | — | 9.46E−01 | −9.32E−01 | — | −7.41E+01 |
| | B3 | — | — | — | — | — | — |
| | B4 | — | — | −9.15E−07 | −1.35E−06 | — | 1.33E−07 |
| | B5 | — | — | — | — | — | — |
| | B6 | — | — | 6.78E−09 | 1.72E−09 | — | −7.21E−12 |
| | B7 | — | — | — | — | — | — |
| | B8 | — | — | −5.77E−12 | 8.76E−13 | — | 3.07E−16 |
| | B9 | — | — | — | — | — | — |
| | B10 | — | — | 1.64E−15 | −1.07E−15 | — | −6.09E−21 |
| Sagittal | r | — | −2.62E+01 | 2.00E+01 | 5.53E+01 | −3.74E+01 | 2.50E+02 |
| line | E1 | — | — | — | — | — | −9.41E−09 |
| | E2 | — | — | — | 6.89E−06 | 3.48E−07 | −1.45E−06 |
| | E3 | — | — | — | — | — | 1.62E−09 |
| | E4 | — | — | — | 8.42E−08 | — | 2.79E−10 |
| | E5 | — | — | — | — | — | −4.72E−13 |
| | E6 | — | — | — | −2.68E−10 | — | −4.45E−14 |
| | E7 | — | — | — | — | — | 5.35E−17 |
| | E8 | — | — | — | 3.44E−13 | — | 3.94E−18 |
| | E9 | — | — | — | — | — | −2.03E−21 |
| | E10 | — | — | — | −1.54E−16 | — | −1.36E−22 |
| Additional | M0_1 | — | — | — | 7.66E−02 | −1.21E−01 | 5.80E−02 |
| term | M1_1 | — | — | — | — | −2.13E−04 | −2.00E−04 |
| | M2_1 | — | — | — | −3.91E−05 | −1.11E−05 | −2.29E−05 |
| | M3_1 | — | — | — | — | 1.42E−07 | 1.29E−07 |
| | M4_1 | — | — | — | — | 5.56E−10 | 2.63E−09 |
| | M5_1 | — | — | — | — | −2.59E−11 | −2.17E−11 |
| | M6_1 | — | — | — | — | 2.46E−13 | −2.07E−13 |
| | M7_1 | — | — | — | — | 2.15E−15 | 1.68E−15 |
| | M8_1 | — | — | — | — | −1.18E−17 | 3.21E−17 |
| | M9_1 | — | — | — | — | −6.13E−20 | −4.20E−20 |
| | M10_1 | — | — | — | — | −9.72E−23 | −1.49E−21 |
| | C3 | −8.67E−03 | — | — | — | — | — |
| | C5 | −7.85E−03 | — | — | — | — | — |

TABLE 6-3
Aspherical surface coefficient

| | Synchronization detection lens | |
|---|---|---|
| | 200 | |
| Coefficient | Incident surface | Exit surface |
| Curvature radius of | 2.60E+01 | — |
| meridional line R | | |
| Curvature radius of | 2.60E+01 | −6.00E+01 |
| sagittal line r | | |

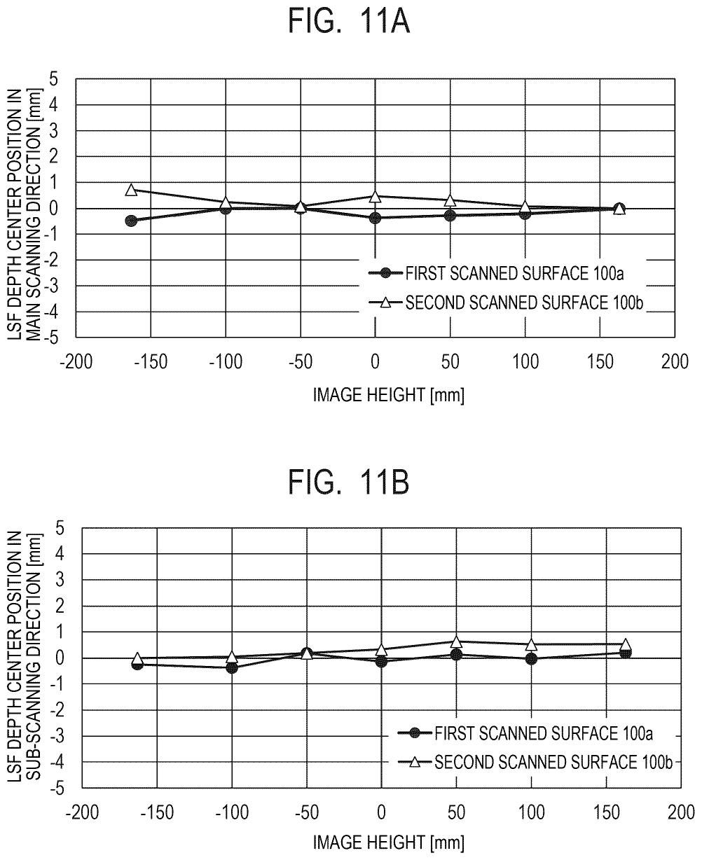

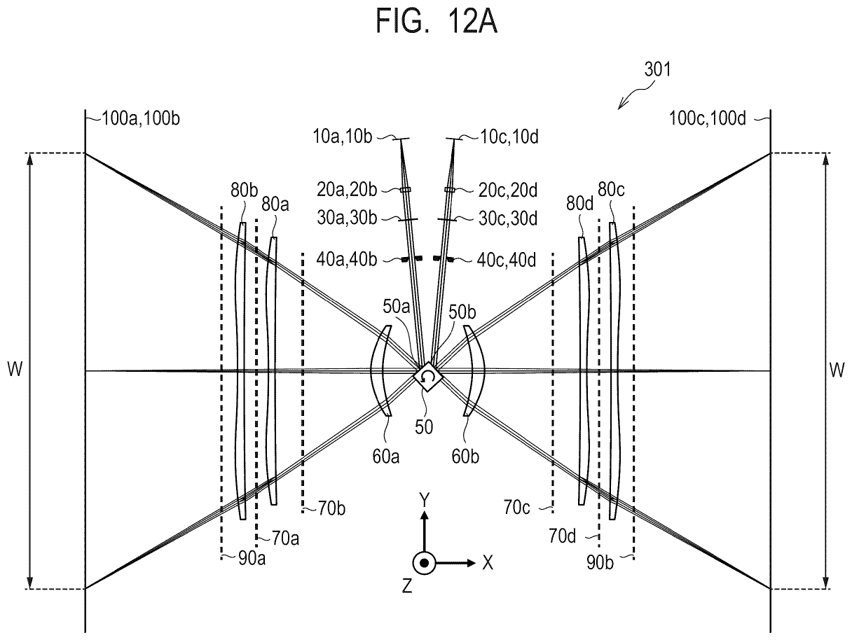

FIGS. 11A and 11B show image height dependencies of the LSF depth center position in the main scanning direction and the LSF depth center position in the sub-scanning direction on each scanned surface in the light scanning apparatus 201 according to the present embodiment, respectively.

As shown in FIGS. 11A and 11B, both of the LSF depth center position in the main scanning direction and the LSF depth center position in the sub-scanning direction are within the range of +1 mm over the entire image height, so that it can be seen that the light scanning apparatus 201 according to the present embodiment achieves a favorable imaging performance.

In the light scanning apparatus 201 according to the present embodiment, DP/W is obtained as 0.25, so that the inequality (5) is satisfied.

Since θᵢₘ is 1.36, the inequalities (6) and (6a) are satisfied.

θ_{bd}/θᵢₘ is obtained as 0.88, so that the inequalities (7) and (7a) are satisfied.

F_{bd}/D_{bd} is obtained as 0.32, so that the inequalities (8) and (8a) are satisfied.

Xₘ/X_{bd} is obtained as 0.77, so that the inequalities (9) and (9a) are satisfied.

As described above, in the light scanning apparatus 201 according to the present embodiment, the deflecting unit 50 and the synchronization detection lens 200 are provided on sides opposite to each other with respect to the bottom surface 2a of the housing 2.

Thereby, it is possible to reduce the size in the direction perpendicular to each of the main scanning direction and the sub-scanning direction, namely in the optical axis directions of the first to fourth imaging optical systems 85a to 85d in the light scanning apparatus 201 according to the present embodiment.

### Third Embodiment

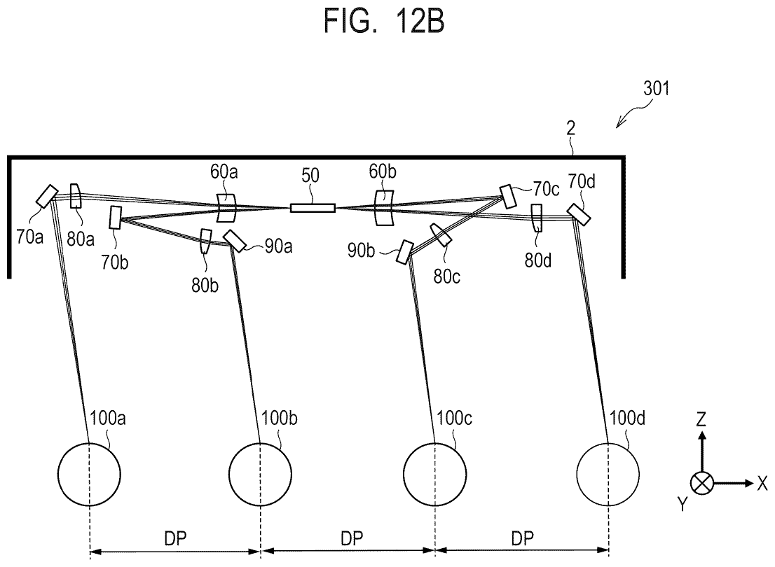

FIGS. 12A and 12B show a partial developed view in the main scanning cross section (corresponding to FIGS. 1A and 1B) and a partial sub-scanning cross sectional view (corresponding to FIG. 2C) of a light scanning apparatus 301 according to a third embodiment of the present invention, respectively.

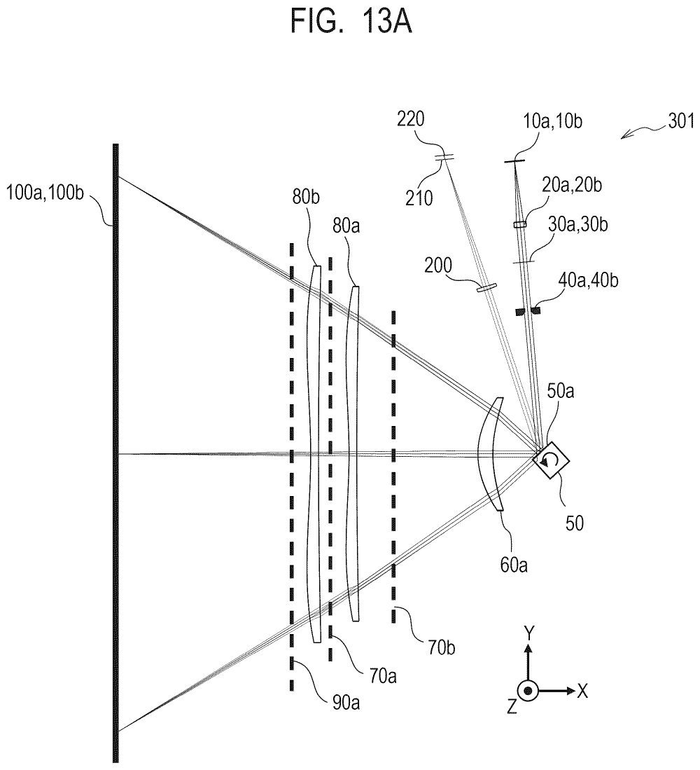

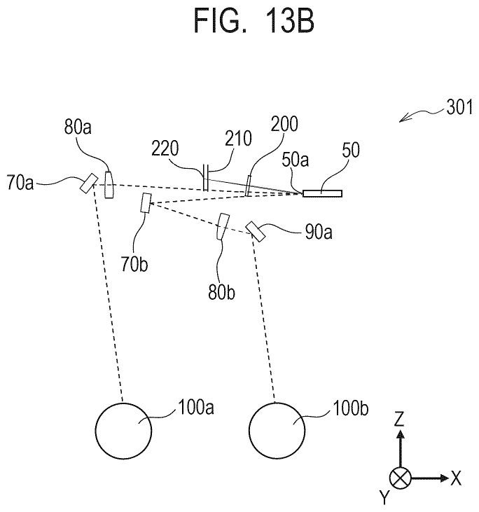

Further, FIGS. 13A and 13B show a partial developed view in the main scanning cross section (corresponding to FIG. 3A) and a partial sub-scanning cross sectional view (corresponding to FIG. 3B) of the light scanning apparatus 301 according to the third embodiment, respectively.

Note that the light scanning apparatus 301 according to the present embodiment has the same configuration as that of the light scanning apparatus 1 according to the first embodiment except that numerical values are different, so that the same members are denoted by the same reference numerals, and description thereof is omitted.

In addition, Tables 7, 8, 9-1, 9-2 and 9-3 below show specification values, a refractive index and coordinates of each optical element, and shapes of optical surfaces of each optical element in the light scanning apparatus 301 according to the present embodiment.

Note that Tables 8, 9-1, 9-2 and 9-3 show only the first and second incident optical systems 75a and 75b, the first and second imaging optical systems 85a and 85b, and the synchronization detection optical system 95.

That is, the third and fourth incident optical systems 75c and 75d, and the third and fourth imaging optical systems 85c and 85d are omitted in Tables 8, 9-1, 9-2 and 9-3.

TABLE 7

| | Parameter | |
|---|---|---|
| Item | [Unit] | Value |
| Design wavelength of first to fourth light fluxes | λ [nm] | 790 |
| LA to LD from first to fourth light sources | | |
| 10a to 10d | | |
| Scanning width of first to fourth scanned surface | W [mm] | 296 |
| 100a to 100d in main scanning direction | | |
| Distance between adjacent photosensitive drums | DP [mm] | 83 |
| Number of deflecting surfaces in deflecting unit 50 | [Surfaces] | 4 |
| Circumscribed diameter of deflecting unit 50 | Pd [mm] | 20 |
| Coordinates of rotation center of deflecting unit 50 | (X, Y) | (6.03, |
| | [mm] | −3.79) |
| Angle in main scanning cross section between | θim [rad] | 1.48 |
| optical axes of first to fourth incident optical | | |
| systems 75a to 75d and optical axes of first to | | |
| fourth imaging optical systems 85a to 85d | | |
| Absolute value of incident angle in sub-scanning | θis [rad] | 0.05 |
| cross section of first to fourth light fluxes LA to | | |
| LD to deflecting surfaces 50a and 50b of | | |
| deflecting unit 50 | | |
| Angle in main scanning cross section between | θbd [rad] | 1.26 |
| optical axis of synchronization detection optical | | |
| system 95 and optical axes of first and second | | |
| imaging optical systems 85a and 85b | | |
| Width in main scanning direction of opening | Am [mm] | 3.75 |
| portion of first to fourth main scanning stops 40a | | |
| to 40d | | |
| Width in sub-scanning direction of opening | As [mm] | 2.84 |
| portion of first to fourth sub-scanning stops | | |
| 30a to 30d | | |
| Focal length in main scanning cross section of | Fbd [mm] | 78.23 |
| synchronization detection lens 200 | | |
| Distance on optical axis between deflection point | Dbd [mm] | 169.20 |
| on deflecting surface of deflecting unit 50 and | | |
| synchronization detection sensor 220 | | |
| Distance in X direction between rotation center of | Xm [mm] | 34.13 |
| deflecting unit 50 and center of incident surface of | | |
| synchronization detection lens 200 | | |
| Distance in X direction between rotation center of | Xbd [mm] | 34.21 |
| deflecting unit 50 and center of incident surface of | | |
| second reflecting element 90a | | |

TABLE 8

| | Refractive | | | | | | |
|---|---|---|---|---|---|---|---|
| | index | Coordinates of surface vertex | | | Direction cosine of optical axis | | |
| Optical surface | (λ = 790 nm) | tc(x) | tc(y) | tc(z) | gx(x) | gx(y) | gx(z) |
| Light emitting | — | −14.08 | 160.91 | −7.62 | −0.09 | 1.00 | −0.05 |
| point of first | | | | | | | |
| light source 10a | | | | | | | |
| Incident surface | 1.53 | −11.15 | 127.48 | −6.03 | −0.09 | 1.00 | −0.05 |
| of first incident | | | | | | | |
| optical element | | | | | | | |
| 20a | | | | | | | |
| Exit surface of | — | −10.89 | 124.50 | −5.89 | −0.09 | 1.00 | −0.05 |
| first incident | | | | | | | |
| optical element | | | | | | | |
| 20a | | | | | | | |
| First sub- | — | −9.22 | 105.44 | −4.99 | −0.09 | 1.00 | 0.00 |
| scanning stop | | | | | | | |
| 30a | | | | | | | |
| First main | — | −6.97 | 79.70 | −3.77 | −0.09 | 1.00 | 0.00 |
| scanning stop | | | | | | | |
| 40a | | | | | | | |
| Deflecting | — | 0.82 | 0.99 | 0.00 | −0.74 | 0.68 | 0.00 |
| surface 50a of | | | | | | | |
| deflecting unit | | | | | | | |
| 50 (when | | | | | | | |
| scanning on- | | | | | | | |
| axis image | | | | | | | |
| height) | | | | | | | |
| Incident surface | 1.53 | −26.00 | 0.00 | 0.00 | −1.00 | 0.00 | 0.00 |
| of upper portion | | | | | | | |
| 60au of first | | | | | | | |
| imaging optical | | | | | | | |
| element | | | | | | | |
| Exit surface of | — | −34.20 | 0.00 | 0.00 | −1.00 | 0.00 | 0.00 |
| upper portion | | | | | | | |
| 60au of first | | | | | | | |
| imaging optical | | | | | | | |
| element | | | | | | | |
| Incident surface | 1.53 | −100.80 | 0.00 | 5.96 | −1.00 | 0.00 | 0.00 |
| of second | | | | | | | |
| imaging optical | | | | | | | |
| element 80a | | | | | | | |
| Exit surface of | — | −105.10 | 0.00 | 5.96 | −1.00 | 0.00 | 0.00 |
| second imaging | | | | | | | |
| optical element | | | | | | | |
| 80a | | | | | | | |
| Reflecting | — | −113.67 | 5.00 | 5.58 | −0.76 | 0.00 | 0.65 |
| surface of first | | | | | | | |
| reflecting | | | | | | | |
| element 70a | | | | | | | |
| First scanned | — | −97.70 | 0.00 | −112.69 | −0.15 | 0.00 | 0.99 |
| surface 100a | | | | | | | |
| Light emitting | — | −14.08 | 160.91 | 7.62 | −0.09 | 1.00 | 0.05 |
| point of second | | | | | | | |
| light source 10b | | | | | | | |
| Incident surface | 1.53 | −11.15 | 127.48 | 6.03 | −0.09 | 1.00 | 0.05 |
| of second | | | | | | | |
| incident optical | | | | | | | |
| element 20b | | | | | | | |
| Exit surface of | — | −10.89 | 124.50 | 5.89 | −0.09 | 1.00 | 0.05 |
| second incident | | | | | | | |
| optical element | | | | | | | |
| 20b | | | | | | | |
| Second sub- | — | −9.22 | 105.44 | 4.99 | −0.09 | 1.00 | 0.00 |
| scanning stop | | | | | | | |
| 30b | | | | | | | |
| Second main | — | −6.97 | 79.70 | 3.77 | −0.09 | 1.00 | 0.00 |
| scanning stop | | | | | | | |
| 40b | | | | | | | |
| Deflecting | — | 0.82 | 0.99 | 0.00 | −0.74 | 0.68 | 0.00 |
| surface 50a of | | | | | | | |
| deflecting unit | | | | | | | |
| 50 (when | | | | | | | |
| scanning on- | | | | | | | |
| axis image | | | | | | | |
| height) | | | | | | | |
| Incident surface | 1.53 | −26.00 | 0.00 | 0.00 | −1.00 | 0.00 | 0.00 |
| of lower portion | | | | | | | |
| 60al of first | | | | | | | |
| imaging optical | | | | | | | |
| element | | | | | | | |
| Exit surface of | — | −34.20 | 0.00 | 0.00 | −1.00 | 0.00 | 0.00 |
| lower portion | | | | | | | |
| 60al of first | | | | | | | |
| imaging optical | | | | | | | |
| element | | | | | | | |
| Incident surface | 1.53 | −42.87 | 0.00 | −15.46 | −0.99 | 0.00 | 0.16 |
| of second | | | | | | | |
| imaging optical | | | | | | | |
| element 80b | | | | | | | |
| Exit surface of | — | −38.63 | 0.00 | −16.15 | −0.99 | 0.00 | 0.16 |
| second imaging | | | | | | | |
| optical element | | | | | | | |
| 80b | | | | | | | |
| Reflecting | — | −81.82 | 0.00 | −4.68 | −1.00 | 0.00 | 0.08 |
| surface of first | | | | | | | |
| reflecting | | | | | | | |
| element 70b | | | | | | | |
| Reflecting | — | −28.10 | −4.50 | −17.47 | −0.70 | 0.00 | −0.71 |
| surface of | | | | | | | |
| second | | | | | | | |
| reflecting | | | | | | | |
| element 90a | | | | | | | |
| Second scanned | — | −14.70 | 0.00 | −112.69 | 0.17 | 0.00 | −0.99 |
| surface 100b | | | | | | | |
| Incident | 1.49 | −28.18 | 88.30 | 4.17 | −0.31 | 0.95 | 0.05 |
| surface of | | | | | | | |
| synchronization | | | | | | | |
| detection lens | | | | | | | |
| 200 | | | | | | | |
| Exit surface of | — | −28.79 | 90.20 | 4.26 | −0.31 | 0.95 | 0.05 |
| synchronization | | | | | | | |
| detection lens | | | | | | | |
| 200 | | | | | | | |
| Synchronization | — | −51.52 | 160.15 | 7.73 | −0.09 | 1.00 | 0.00 |
| detection slit | | | | | | | |
| 210 | | | | | | | |
| Synchronization | — | −52.14 | 162.04 | 7.83 | −0.09 | 1.00 | 0.00 |
| detection sensor | | | | | | | |
| 220 | | | | | | | |

TABLE 9-1

| | Aspherical surface coefficient | | | | | | |
|---|---|---|---|---|---|---|---|
| | | | | Upper portion 60au | | | |
| | | First incident | | of first imaging | | Second imaging | |
| | | optical element 20a | | optical element | | optical element 80a | |
| | | Incident | Exit | Incident | Exit | Incident | Exit |
| | Coefficient | surface | surface | surface | surface | surface | surface |
| Meridional | R | — | −3.72E+01 | −7.20E+01 | −4.32E+01 | 4.00E+03 | 3.46E+02 |
| line | K | — | — | 8.92E−01 | −5.70E−01 | — | −9.06E+01 |
| | B3 | — | — | — | — | — | — |
| | B4 | — | — | −7.61E−07 | −2.12E−07 | — | −2.16E−07 |
| | B5 | — | — | — | — | — | — |
| | B6 | — | — | 6.79E−09 | 1.67E−09 | — | 1.80E−11 |
| | B7 | — | — | — | — | — | — |
| | B8 | — | — | −5.89E−12 | 1.27E−12 | — | −1.08E−15 |
| | B9 | — | — | — | — | — | — |
| | B10 | — | — | 1.62E−15 | −1.43E−15 | — | 3.06E−20 |
| Sagittal | r | — | −2.62E+01 | 2.00E+01 | 2.06E+01 | 2.68E+01 | 2.94E+02 |
| line | E1 | — | — | — | — | — | −7.95E−07 |
| | E2 | — | — | — | 1.56E−05 | −5.14E−06 | −2.37E−06 |
| | E3 | — | — | — | — | — | −3.30E−09 |
| | E4 | — | — | — | −3.39E−08 | — | −2.46E−10 |
| | E5 | — | — | — | — | — | 1.49E−12 |
| | E6 | — | — | — | 3.96E−11 | — | 1.69E−14 |
| | E7 | — | — | — | — | — | −2.51E−16 |
| | E8 | — | — | — | −6.56E−14 | — | −1.80E−18 |
| | E9 | — | — | — | — | — | 1.42E−20 |
| | E10 | — | — | — | 5.40E−17 | — | 6.86E−23 |
| Additional | M0_1 | — | — | — | −3.93E−02 | −1.51E−01 | 1.09E−02 |
| term | M1_1 | — | — | — | — | −2.20E−05 | −9.67E−06 |
| | M2_1 | — | — | — | 3.68E−05 | −2.59E−05 | −3.99E−05 |
| | M3_1 | — | — | — | — | 1.31E−07 | 1.17E−07 |
| | M4_1 | — | — | — | — | 5.71E−09 | 7.94E−09 |
| | M5_1 | — | — | — | — | −3.85E−11 | −3.14E−11 |
| | M6_1 | — | — | — | — | 8.95E−14 | −6.61E−13 |
| | M7_1 | — | — | — | — | 5.08E−15 | 3.77E−15 |
| | M8_1 | — | — | — | — | −2.76E−17 | 8.31E−17 |
| | M9_1 | — | — | — | — | −2.34E−19 | −1.51E−19 |
| | M10_1 | — | — | — | — | −5.21E−22 | −5.65E−21 |
| | C3 | −8.67E−03 | — | — | — | — | — |
| | C5 | −7.85E−03 | — | — | — | — | — |

TABLE 9-2

| | Aspherical surface coefficient | | | | | | |
|---|---|---|---|---|---|---|---|
| | | | | Lower portion 60al | | | |
| | | Second incident | | of first imaging | | Second imaging | |
| | | optical element 20b | | optical element | | optical element 80b | |
| | | Incident | Exit | Incident | Exit | Incident | Exit |
| | Coefficient | surface | surface | surface | surface | surface | surface |
| Meridional | R | — | −3.72E+01 | −7.20E+01 | −4.42E+01 | 4.00E+03 | −3.84E+02 |
| line | K | — | — | 8.92E−01 | −1.15E+00 | — | −7.67E+01 |
| | B3 | — | — | — | — | — | — |
| | B4 | — | — | −7.61E−07 | −1.53E−06 | — | 1.34E−07 |
| | B5 | — | — | — | — | — | — |
| | B6 | — | — | 6.79E−09 | 1.77E−09 | — | −7.43E−12 |
| | B7 | — | — | — | — | — | — |
| | B8 | — | — | −5.89E−12 | 9.64E−13 | — | 3.32E−16 |
| | B9 | — | — | — | — | — | — |
| | B10 | — | — | 1.62E−15 | −1.19E−15 | — | −7.21E−21 |
| Sagittal | r | — | −2.62E+01 | 2.00E+01 | 5.45E+01 | −4.61E+01 | 1.10E+02 |
| line | E1 | — | — | — | — | — | 1.93E−06 |
| | E2 | — | — | — | 5.86E−06 | −1.37E−08 | −1.78E−06 |
| | E3 | — | — | — | — | — | 6.13E−10 |
| | E4 | — | — | — | 1.02E−07 | — | 2.81E−10 |
| | E5 | — | — | — | — | — | −1.78E−13 |
| | E6 | — | — | — | −2.91E−10 | — | −4.07E−14 |
| | E7 | — | — | — | — | — | 1.82E−17 |
| | E8 | — | — | — | 3.51E−13 | — | 3.25E−18 |
| | E9 | — | — | — | — | — | −5.54E−22 |
| | E10 | — | — | — | −1.62E−16 | — | −1.00E−22 |
| Additional | M0_1 | — | — | — | 1.12E−01 | −1.49E−01 | 7.95E−02 |
| term | M1_1 | — | — | — | — | −1.94E−05 | −8.17E−06 |
| | M2_1 | — | — | — | −3.73E−05 | −2.65E−07 | −1.51E−05 |
| | M3_1 | — | — | — | — | 4.97E−08 | 4.53E−08 |
| | M4_1 | — | — | — | — | −5.01E−10 | 1.81E−09 |
| | M5_1 | — | — | — | — | −1.01E−11 | −8.59E−12 |
| | M6_1 | — | — | — | — | 2.09E−13 | −1.65E−13 |
| | M7_1 | — | — | — | — | 9.58E−16 | 7.72E−16 |
| | M8_1 | — | — | — | — | −2.64E−18 | 2.41E−17 |
| | M9_1 | — | — | — | — | −2.84E−20 | −1.97E−20 |
| | M10_1 | — | — | — | — | 7.55E−23 | −4.46E−22 |
| | C3 | −8.67E−03 | — | — | — | — | — |
| | C5 | −7.85E−03 | — | — | — | — | — |

TABLE 9-3
Aspherical surface coefficient

| | Synchronization detection lens | |
|---|---|---|
| | 200 | |
| Coefficient | Incident surface | Exit surface |
| Curvature radius of | 3.79E+01 | — |
| meridional line R | | |
| Curvature radius of | 3.79E+01 | −4.50E+01 |
| sagittal line r | | |

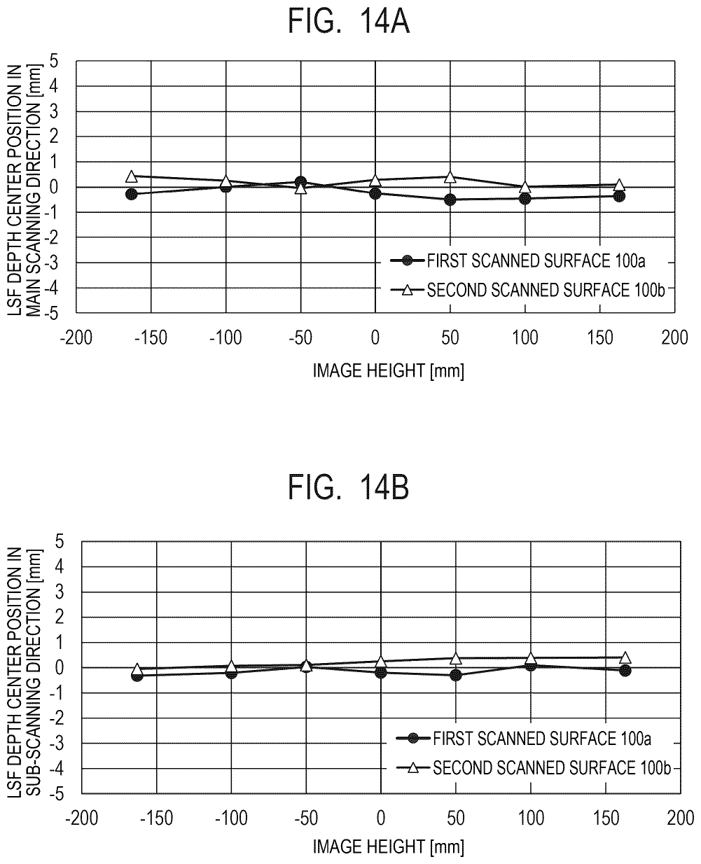

FIGS. 14A and 14B show image height dependencies of the LSF depth center position in the main scanning direction and the LSF depth center position in the sub-scanning direction on each scanned surface in the light scanning apparatus 301 according to the present embodiment, respectively.

As shown in FIGS. 14A and 14B, both of the LSF depth center position in the main scanning direction and the LSF depth center position in the sub-scanning direction are within the range of +1 mm over the entire image height, so that it can be seen that the light scanning apparatus 301 according to the present embodiment achieves a favorable imaging performance.

In the light scanning apparatus 301 according to the present embodiment, DP/W is obtained as 0.28, so that the inequality (5) is satisfied.

Since θᵢₘ is 1.48, the inequalities (6) and (6a) are satisfied.

θ_{bd}/θᵢₘ is obtained as 0.85, so that the inequalities (7) and (7a) are satisfied.

F_{bd}/D_{bd} is obtained as 0.46, so that the inequalities (8) and (8a) are satisfied.

Xₘ/X_{bd} is obtained as 1.00, so that the inequalities (9) and (9a) are satisfied.

As described above, in the light scanning apparatus 301 according to the present embodiment, the deflecting unit 50 and the synchronization detection lens 200 are provided on sides opposite to each other with respect to the bottom surface 2a of the housing 2.

Thereby, it is possible to reduce the size in the direction perpendicular to each of the main scanning direction and the sub-scanning direction, namely in the optical axis directions of the first to fourth imaging optical systems 85a to 85d in the light scanning apparatus 301 according to the present embodiment.

Table 10 below shows the relationship between numerical values and inequalities in each of the light scanning apparatuses according to the first to third embodiments.

TABLE 10

| | | First | Second | Third |
|---|---|---|---|---|
| Inequalities | | embodiment | embodiment | embodiment |
| (5) | 0.25 ≤ DP/W ≤ 0.30 | 0.25 | 0.25 | 0.28 |
| (6) | 1.00 < θᵢₘ < 1.50 | 1.36 | 1.36 | 1.48 |
| (6a) | 1.20 < θᵢₘ < 1.50 | | | |
| (7) | 0.80 < θ_{bd}/θᵢₘ < 0.95 | 0.91 | 0.88 | 0.85 |
| (7a) | 0.84 < θ_{bd}/θᵢₘ < 0.95 | | | |
| (8) | 0.30 < F_{bd}/D_{bd} < 0.70 | 0.37 | 0.32 | 0.46 |
| (8a) | 0.30 < F_{bd}/D_{bd} < 0.50 | | | |
| (9) | 0.60 < Xₘ/X_{bd} < 1.50 | 0.84 | 0.77 | 1.00 |
| (9a) | 0.70 < Xₘ/X_{bd} < 1.20 | | | |

According to the present embodiments, a light scanning apparatus having a small size and a simple configuration can be provided.

### [Image Forming Apparatus]

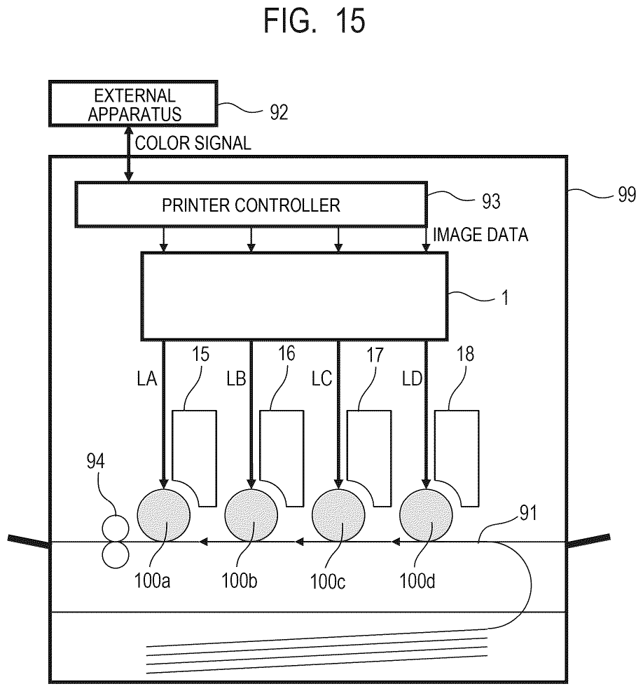

FIG. 15 shows a sub-scanning cross sectional view of a main part of an image forming apparatus 99 including the light scanning apparatus 1 according to any one of the first to third embodiments.

The image forming apparatus 99 is a tandem-type color image forming apparatus in which the light scanning apparatus 1 according to any one of the first to third embodiments records image information on surfaces of four photosensitive drums serving as image bearing members.

The image forming apparatus 99 includes the light scanning apparatus 1 according to any one of the first to third embodiments, and first, second, third and fourth photosensitive drums 100a, 100b, 100c and 100d as image bearing members.

Further, the image forming apparatus 99 includes first, second, third and fourth developing units 15, 16, 17 and 18, a conveying belt 91, a printer controller 93, and a fixing unit 94.

As shown in FIG. 15, color signals of R (red), G (green) and B (blue) output from an external apparatus 92 such as a personal computer are input to the image forming apparatus 99.

Then, the input color signals are converted into image data (dot data) of C (cyan), M (magenta), Y (yellow) and K (black) by a printer controller 93 in the apparatus.

Next, the converted image data is input to the light scanning apparatus 1 according to any one of the first to third embodiments.

Then, the photosensitive surfaces of the first to fourth photosensitive drums 100a to 100d are scanned in the main scanning direction by the first, second, the third and fourth light fluxes LA, LB, LC and LD modulated according to each image data and emitted from the light scanning apparatus 1, respectively.

Charging rollers (not shown) for uniformly charging the surfaces of the first to fourth photosensitive drums 100a to 100d are provided so as to abut on the surfaces.

Then, the surfaces of the first to fourth photosensitive drums 100a to 100d charged by the charging rollers are irradiated with the first to fourth light fluxes LA to LD by the light scanning apparatus 1.

As described above, the first to fourth light fluxes LA to LD are modulated based on image data of each color, and electrostatic latent images are formed on the surfaces of the first to fourth photosensitive drums 100a to 100d by irradiating the surfaces with the first to fourth light fluxes LA to LD, respectively.

Then, the formed electrostatic latent images are developed as toner images by the first to fourth developing units 15 to 18 arranged so as to abut on the first to fourth photosensitive drums 100a to 100d, respectively.

Next, the developed toner images are multiply transferred onto a sheet (a transferred material) (not shown) conveyed on the conveying belt 91 by transferring rollers (a transferring unit) (not shown) arranged so as to face the first to fourth photosensitive drums 100a to 100d. Thereby, one full-color image is formed on the sheet.

Then, the sheet on which the unfixed toner image is transferred is further conveyed to a fixing unit 94 provided on a downstream side (on the left side in FIG. 15) of the first to fourth photosensitive drums 100a to 100d by the conveying belt 91.

The fixing unit 94 includes a fixing roller having a fixing heater (not shown) therein and a pressurizing roller arranged so as to come into pressure contact with the fixing roller.

Then, the sheet conveyed by the conveying belt 91 is heated while being pressed by a pressure contact portion between the fixing roller and the pressurizing roller to fix the unfixed toner image on the sheet.

Further, a sheet discharging roller (not shown) is arranged at a downstream side of the fixing unit 94, and the sheet discharging roller discharges the fixed sheet to the outside of the image forming apparatus 99.

In the image forming apparatus 99, image signals (image information) are recorded on photosensitive surfaces of first to fourth photosensitive drums 100a to 100d corresponding to respective colors of C (cyan), M (magenta), Y (yellow) and K (black) by the light scanning apparatus 1. Thereby, a color image can be printed at a high speed.

As the external apparatus 92, a color image reading apparatus including a CCD sensor may be used, for example.

In this case, a color digital copying machine is formed by the color image reading apparatus and the image forming apparatus 99.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-166647, filed Sep. 28, 2023, which is hereby incorporated by reference herein in its entirety.

What is claimed is:

1. A light scanning apparatus, comprising:
a deflecting unit configured to deflect a first light flux to scan a first scanned surface in a main scanning direction;
a first imaging optical system configured to guide the first light flux deflected by the deflecting unit to the first scanned surface;
a light receiving element configured to receive the first light flux deflected by the deflecting unit without the first imaging optical system;
a first optical element configured to guide the first light flux deflected by the deflecting unit to the light receiving element; and
a holding member configured to hold the deflecting unit, the first imaging optical system, the light receiving element and the first optical element,
wherein the first optical element and the deflecting unit are arranged on sides opposite to each other with respect to a first surface of the holding member.

2. The light scanning apparatus according to claim 1, further comprising a second imaging optical system configured to guide a second light flux deflected by the deflecting unit to a second scanned surface,
wherein the deflecting unit is configured to deflect the second light flux to scan the second scanned surface in the main scanning direction.

3. The light scanning apparatus according to claim 2, wherein a following condition is satisfied:
0.25≤DP/W≤0.30
where DP represents a distance between a first intersecting point of the first scanned surface and an optical axis of the first imaging optical system, and a second intersecting point of the second scanned surface and an optical axis of the second imaging optical system, and W represents a scanning width on each of the first and second scanned surfaces.

4. The light scanning apparatus according to claim 2, wherein the deflecting unit is configured to deflect the first and second light fluxes by a first deflecting surface.

5. The light scanning apparatus according to claim 4, wherein the second scanned surface is arranged between the deflecting unit and the first scanned surface in a first direction parallel to a straight line passing through a first intersecting point of the first scanned surface and an optical axis of the first imaging optical system, and a second intersecting point of the second scanned surface and an optical axis of the second imaging optical system.

6. The light scanning apparatus according to claim 4, wherein a following condition is satisfied:
$$0.6 < {X}_{m} / {X}_{b d} < 1.5$$
where X_{bd} represents a distance between a center of the deflecting unit and a center of an incident surface of the first optical element in a first direction parallel to a straight line passing through a first intersecting point of the first scanned surface and an optical axis of the first imaging optical system, and a second intersecting point of the second scanned surface and an optical axis of the second imaging optical system, and Xₘ represents a distance in the first direction between the center of the deflecting unit and a center of an incident surface of a second optical element arranged closest to the deflecting unit among optical elements provided on optical paths of the first and second light fluxes deflected by the deflecting unit.

7. The light scanning apparatus according to claim 1, further comprising a reflecting element configured to guide the first light flux deflected by the deflecting unit to the first scanned surface,
wherein the holding member is configured to hold the reflecting element, and
wherein the first optical element and the reflecting element are arranged on sides opposite to each other with respect to the first surface of the holding member.

8. The light scanning apparatus according to claim 1, wherein the first optical element and the first imaging optical system are arranged on sides opposite to each other with respect to the first surface of the holding member.

9. The light scanning apparatus according to claim 1, wherein the first optical element is configured to condense the first light flux deflected by the deflecting unit on a light receiving surface of the light receiving element.

10. The light scanning apparatus according to claim 1, further comprising a controller configured to control a light emission timing of a light source for emitting the first light flux based on a signal from the light receiving element.

11. The light scanning apparatus according to claim 1, wherein the holding member is configured to hold an upper surface of the first optical element.

12. The light scanning apparatus according to claim 1, wherein the light receiving element and the deflecting unit are arranged on sides opposite to each other with respect to a second surface of the holding member.

13. The light scanning apparatus according to claim 1, wherein the light receiving element and the first optical element are arranged on sides opposite to each other with respect to a second surface of the holding member.

14. The light scanning apparatus according to claim 1, wherein a following condition is satisfied:
$$0.3 < {F}_{b d} / {D}_{b d} < 0.70$$
where D_{bd} represents a distance on an optical axis of the first optical element between the light receiving element and a deflection point of the deflecting unit for a principal ray of the first light flux, and F_{bd} represents a focal length in a main scanning cross section of the first optical element.

15. The light scanning apparatus according to claim 1, further comprising an incident optical system configured to cause the first light flux to be incident on the deflecting unit,
wherein a following condition is satisfied:
$$1. < {θ}_{i m} < 1.5$$
where θᵢₘ (radian) represents an angle formed by an optical axis of the incident optical system and an optical axis of the first imaging optical system when they are projected on a main scanning cross section.

16. The light scanning apparatus according to claim 1, further comprising an incident optical system configured to cause the first light flux to be incident on the deflecting unit,
wherein a following condition is satisfied:
$$0.80 < {θ}_{b d} / {θ}_{i m} < 0.95$$
where θᵢₘ represents an angle formed by an optical axis of the incident optical system and an optical axis of the first imaging optical system when they are projected on a main scanning cross section, and θ_{bd} represents an angle formed by an optical axis of the first optical element and the optical axis of the first imaging optical system when they are projected in the main scanning cross section.

17. The light scanning apparatus according to claim 1, further comprising second, third and fourth imaging optical systems configured to guide second, third and fourth light fluxes deflected by the deflecting unit to second, third and fourth scanned surfaces, respectively,
wherein the deflecting unit is configured to deflect the second, third and fourth light fluxes to scan the second, third and fourth scanned surfaces in the main scanning direction, respectively,
wherein the first and second light fluxes are obliquely incident on a first deflecting surface of the deflecting unit at different angles from each other with respect to a main scanning section in a sub-scanning cross section, and
wherein the third and fourth light fluxes are obliquely incident on a second deflecting surface of the deflecting unit at different angles from each other with respect to the main scanning section in the sub-scanning section.

18. An image forming apparatus, comprising:
the light scanning apparatus according to claim 1;
a developing unit configured to develop an electrostatic latent image formed on the first scanned surface by the light scanning apparatus as a toner image;
a transferring unit configured to transfer the developed toner image to a transferred material; and
a fixing unit configured to fix the transferred toner image to the transferred material.

19. An image forming apparatus, comprising:
the light scanning apparatus according to claim 1; and
a printer controller configured to convert a signal output from an external apparatus into image data to input the image data to the light scanning apparatus.
